(19) United States
(12) Patent Application Publication
(10) Pub. No.: US 2026/0176478 A1
(43) Pub. Date: Jun. 25, 2026

(54) SURFACE MODIFIER

(71) Applicants: DAIKIN INDUSTRIES, LTD., Osaka (JP); The University of Osaka, Osaka (JP)

(72) Inventors: Yuu MIZOTE, Osaka (JP); Masahiro HIGASHI, Osaka (JP); Ikuo YAMAMOTO, Osaka (JP); Yuko SHIOTANI, Osaka (JP); Ryo AKUTA, Osaka (JP); Takumi SHIMOSUKI, Osaka (JP); Satoru YOSHIZAKI, Osaka (JP); Nobuyuki MATUBAYASI, Osaka (JP); Hidekazu KOJIMA, Osaka (JP)

(73) Assignees: DAIKIN INDUSTRIES, LTD., Osaka (JP); The University of Osaka, Osaka (JP)

(21) Appl. No.: 19/424,451

(22) Filed: Dec. 18, 2025

(30) Foreign Application Priority Data
Dec. 19, 2024 (JP) 2024-224444

(51) Int. Cl. C09D 5/16; C07F 7/08; C08F 120/10; C08F 120/54; C09D 133/14; C09D 133/24; D06M 15/356; D21H 19/12; D21H 21/16

(52) U.S. Cl. CPC C09D 5/1668; C07F 7/081; C08F 120/10; C08F 120/54; C09D 133/14; C09D 133/24; D06M 15/3568; D21H 19/12; D21H 21/16; D06M 2200/12

(57) ABSTRACT

A surface modifier comprising a liquid-repellent compound having a Z group represented by the following formula:

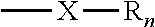

wherein X is a direct bond or a 1+n valent group,
R is independently at each occurrence an aliphatic hydrocarbon group having 4 or more and 40 or less carbon atoms, having at least one alkylsilyl group, and optionally having a substituent, and
n is 1 or more and 3 or less,
wherein the alkylsilyl group is represented by the following formula:

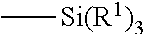

wherein R¹ is each independently a hydrogen atom or an aliphatic hydrocarbon group having 1 to 10 carbon atoms and optionally having a substituent, and at least one R¹ is an aliphatic hydrocarbon group having 1 or more and 10 or less carbon atoms and optionally having a substituent.

### CROSS-REFERENCE TO RELATED APPLICATIONS

This application claims priority to Japanese Patent Application No. 2024-224444, filed on Dec. 19, 2024, the entire contents of which are incorporated herein by reference.

### TECHNICAL FIELD

The present disclosure relates to a surface modifier.

### BACKGROUND ART

In recent years, development of fluorine-free repellents capable of imparting liquid repellency (water-repellency and/or oil-repellency) to various substrates has been promoted.

### DESCRIPTION OF THE RELATED ART

JACS, 1994, 116, 8952./Christopher A. Willoughby and Stephen L. Buchwald discloses synthesis of an amine compound from an imine compound with an asymmetric hydrogenation catalyst. As the amine compound, an amine compound in which a hydrocarbon group having a trimethylsilyl group is directly bonded to a carbon atom of pyrrolidine is disclosed, but use thereof as a surface modifier is not disclosed.

### SUMMARY

One aspect of the present disclosure is as follows:

A surface modifier comprising a liquid-repellent compound having a Z group represented by the following formula:

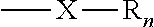

wherein X is a direct bond or a 1+n valent group,
R is independently at each occurrence an aliphatic hydrocarbon group having 4 or more and 40 or less carbon atoms, having at least one alkylsilyl group, and optionally having a substituent, and
n is 1 or more and 3 or less,
wherein the alkylsilyl group is represented by the following formula:

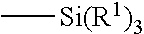

wherein R¹ is each independently a hydrogen atom or an aliphatic hydrocarbon group having 1 to 10 carbon atoms and optionally having a substituent, and at least one R¹ is an aliphatic hydrocarbon group having 1 or more and 10 or less carbon atoms and optionally having a substituent.

### DESCRIPTION OF EMBODIMENTS

One embodiment of the present disclosure provides a novel surface modifier capable of imparting liquid repellency to textile products and/or paper products.

One embodiment of the of the present disclosure can impart excellent liquid repellency (in particular, water-repellency) to textile products and/or paper products.

### DEFINITION OF TERMS

As used herein, the “n valent group” refers to a group having n bonds, i.e., a group forming n bonds. The “n valent organic group” refers to a n valent group containing carbon. Such organic groups are not limited, but can be hydrocarbon groups or derivatives thereof. The derivative of the hydrocarbon group refers to a group that has one or more of N, O, S, Si, amide, sulfonyl, siloxane, carbonyl, carbonyloxy, halogen and the like at the end or in the molecular chain of a hydrocarbon group.

As used herein, the “hydrocarbon group” refers to a group containing carbon and hydrogen and a group in which a hydrogen atom is removed from the hydrocarbon. Such hydrocarbon groups are not limited, but include C₁₋₄₀ hydrocarbon groups, such as an aliphatic hydrocarbon group and an aromatic hydrocarbon group. The above “aliphatic hydrocarbon group” may be either linear, branched, or cyclic, and may be either saturated or unsaturated. The hydrocarbon group may include one or more ring structures. The hydrocarbon group may be substituted by one or more substituents.

Whether or not the phrases “independently at each occurrence”, “independently with each other”, “each independently” or similar expressions are explicitly described herein, unless otherwise described that they are exceptions, when a plurality of terms (symbols) that can occur in a chemical structure is defined, such definition is applied independently to each occurrence.

The chemical structures described herein should be understood not to encompass chemical structures that are recognized by those skilled in the art as being chemically impossible or extremely unstable.

### <Surface Modifier>

The surface modifier of the present disclosure comprises a liquid-repellent compound. The surface modifier of the present disclosure may consist only of a liquid-repellent compound, or contain other components in addition to the liquid-repellent compound.

The surface modifier of the present disclosure imparts liquid-repellency (water-repellency, oil-repellency, oil resistance and/or water resistance) to a substrate (e.g., fiber substrate, paper substrate), and may function as at least one selected from a water-repellent agent, an oil-repellent agent, an oil-resistant agent and a water-resistant agent. The surface modifier of the present disclosure can impart good oil resistance (oil-repellency) and/or water resistance (water-repellency) to a substrate, and for example, can impart both oil resistance and water resistance to a substrate.

The surface modifier of the present disclosure may not include one selected from the group consisting of a compound having a fluoroalkyl group having 8 or more carbon atoms, a compound having a perfluoroalkyl group having 8 or more carbon atoms, a compound having a fluoroalkyl group having 4 or more carbon atoms, a compound having a perfluoroalkyl group having 4 or more carbon atoms, a compound having a perfluoroalkyl group, a compound having a fluoroalkyl group and a compound having a fluorine atom. The surface modifier of the present disclosure can impart liquid-repellency to substrates without these fluorine compounds. Herein, the term fluoroalkyl group may be intended to mean a group formed by replacing one or more hydrogen atoms on the carbon atoms of an alkyl group each with a fluorine atom.

### {Liquid-Repellent Compound}

The liquid-repellent compound in the present disclosure has a Z group represented by the following formula:

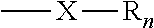

wherein X is a direct bond or a 1+n valent group,
R is independently at each occurrence an aliphatic hydrocarbon group having 4 or more and 40 or less carbon atoms, having at least one alkylsilyl group, and optionally having a substituent, and
n is 1 or more and 3 or less,
wherein the alkylsilyl group is represented by the following formula:

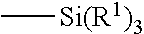

wherein R¹ is each independently a hydrogen atom or an aliphatic hydrocarbon group having 1 to 10 carbon atoms and optionally having a substituent, and at least one R¹ is an aliphatic hydrocarbon group having 1 or more and 10 or less carbon atoms and optionally having a substituent.

The liquid-repellent compound in the present disclosure can adhere to a substrate and impart water- and oil-repellency to the substrate. Specifically, the liquid-repellent compound in the present disclosure can impart liquid repellency (water-repellency, oil-repellency, oil resistance, and/or water resistance) to a substrate. The liquid-repellent compound in the present disclosure can impart good oil resistance (oil-repellency) and/or water resistance (water-repellency) to a substrate, and, for example, can impart both oil resistance and water resistance to a substrate.

### [Characteristics of Liquid-Repellent Compound]

The liquid-repellent compound may have a water contact angle of 35° or more, 40° or more, 45° or more, 50° or more, 55° or more, 65° or more, 75° or more, 80° or more, 85° or more, 90° or more, 95° or more, or 100° or more. The liquid-repellent compound may have a water contact angle of 160° or less, 140° or less, 130° or less, 120° or less, 110° or less, 100° or less, or 90° or less. A water contact angle of the liquid-repellent compound of the lower limit or more can impart good coatability (in particular water-repellency) to a substrate. The water contact angle is a static contact angle of a liquid-repellent compound to a spin-coated film, which is obtained by dropping 2 μL of water on a spin-coated film and measuring the contact angle one second after the droplet reaches the film as shown in Examples.

The liquid-repellent compound may have a HD (n-hexadecane) contact angle of 10° or more, 15° or more, 25° or more, 35° or more, 40° or more, 45° or more, 55° or more, or 65° or more, and preferably 30° or more. The liquid-repellent compound may have a HD contact angle of 100° or less, 90° or less, or 75° or less. A HD contact angle of the liquid-repellent compound of the lower limit or more can impart good liquid-repellency (in particular oil-repellency) to a substrate. The HD contact angle is a static contact angle of a liquid-repellent compound to a spin-coated film, which is obtained by dropping 2 μL of HD on a spin-coated film and measuring the contact angle one second after the droplet reaches the film.

Examples of the liquid-repellent compound include, but are not limited to, a compound formed by modifying at least one selected from the group consisting of a polycarboxylic acid, a polyol, a polyamine, an aromatic compound, a nitrogen-containing cyclic compound, an isocyanate derivative, and derivatives thereof, with the Z group. The liquid-repellent compound may be a combination of a plurality of (e.g., two or three) liquid-repellent compounds.

### [Aliphatic Hydrocarbon Group]

In the present disclosure, the liquid-repellent compound preferably has an aliphatic hydrocarbon group having 4 or more and 40 or less carbon atoms, having at least one alkylsilyl group, and optionally having a substituent. The aliphatic hydrocarbon group is preferably a saturated aliphatic hydrocarbon group. The aliphatic hydrocarbon group may be cyclic, linear, or branched, and preferable linear.

The aliphatic hydrocarbon group may have 4 or more, 6 or more, 8 or more, 10 or more, 12 or more, 14 or more, 16 or more, 18 or more, 20 or more, or 22 or more carbon atoms, preferably 6 or more, 10 or more, 12 or more, or 16 or more carbon atoms. The hydrocarbon group may have 40 or less, 35 or less, 30 or less, 25 or less, 20 or less, 15 or less, or 10 or less carbon atoms, preferably 30 or less, 25 or less, or 20 or less carbon atoms.

The aliphatic hydrocarbon group may have a substituent, but is preferably non-substituted. Examples of substituents include —OR′, —N(R′)₂, —COOR′, and a halogen atom (wherein R′ is independently at each occurrence a hydrogen atom or a hydrocarbon group having 1 to 30, 1 to 20, 1 to 10, or 1 to 4 carbon atoms). The substituent may have or be free of active hydrogen. The number of substituent may be 6 or less, 5 or less, 4 or less, 3 or less, 2 or less, 1 or less, or 0. In the aliphatic hydrocarbon group having a substituent, the amount of carbon atom relative to the amount of carbon atom and heteroatom may be 70 mol % or more, 80 mol % or more, 90 mol % or more, 95 mol % or more, or 99 mol % or more, and is preferably 75 mol % or more. In the aliphatic hydrocarbon group having a substituent, the amount of carbon atom relative to the carbon atom and the heteroatom may be 95 mol % or less, 90 mol % or less, 85 mol % or less, or 80 mol % or less.

The alkyl group bonded to Si of the alkylsilyl group may be an aliphatic hydrocarbon group having 1 to 10 carbon atoms, and may be branched or linear, and more preferably linear.

The alkyl group bonded to Si of the alkylsilyl group may have 1 or more, 2 or more, 3 or more, 4 or more, or 5 or more carbon atoms, preferably 1 carbon atom, and 10 or less, 9 or less, 8 or less, 7 or less, or 6 or less carbon atoms, preferably 9 or less, 8 or less, or 7 or less carbon atoms.

The aliphatic hydrocarbon group, mentioned here, having 4 to 40 carbon atoms and having at least one alkylsilyl group can correspond to R described later.

The alkylsilyl group is a group in which one or more alkyl groups are bonded to a trivalent silyl group. The alkylsilyl group may be at least one alkylsilyl group selected from a monoalkylsilyl group, a dialkylsilyl group, and a trialkylsilyl group.

For example, a hydrogen atom, a hydroxyl group, or an aromatic ring (e.g., a benzene ring) may be bonded to the silyl group of the alkylsilyl group.

The liquid-repellent compound may have 1 or more, 2 or more, 3 or more, 4 or more, 5 or more, 7 or more, 10 or more, 15 or more, 20 or more, 25 or more, 50 or more, 75 or more, 100 or more, 300 or more, or 500 or more alkylsilyl groups, preferably 10 or more alkylsilyl groups, per molecule. The liquid-repellent compound may have 1,000 or less, 500 or less, 300 or less, 100 or less, 75 or less, 50 or less, 25 or less, 20 or less, 15 or less, 10 or less, 7 or less, 5 or less, 4 or less, 3 or less, or 2 or less alkylsilyl groups per molecule.

The amount of the alkylsilyl group may be 1% by weight or more, 3% by weight or more, 5% by weight or more, 10% by weight or more, 20% by weight or more, or 30% by weight or more, preferably 5% by weight or more, of the liquid-repellent compound. The amount of the alkylsilyl group may be 80% by weight or less, 70% by weight or less, 60% by weight or less, 50% by weight or less, 40% by weight or less, 30% by weight or less, or 25% by weight or less, preferably 70% by weight or less, of the liquid-repellent compound.

The solvation free energy of the liquid-repellent compound is preferably as close to 0 as possible. Specifically, the liquid-repellent compound may have a solvation free energy of −1.50 kcal/mol or more, −1.40 kcal/mol or more, −1.30 kcal/mol or more, −1.20 kcal/mol or more, −1.10 kcal/mol or more, −1.00 kcal/mol or more, −0.90 kcal/mol or more, −0.80 kcal/mol or more, −0.70 kcal/mol or more, −0.50 kcal/mol or more, −0.30 kcal/mol or more, or −0.10 kcal/mol or more, and may have a solvation free energy of 0 kcal/mol or less.

### [Z]

The liquid-repellent compound in the present disclosure has a Z group represented by the following formula:

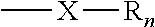

wherein X is a direct bond or a 1+n valent group,
R is independently at each occurrence an aliphatic hydrocarbon group having 4 or more and 40 or less carbon atoms, having at least one alkylsilyl group, and optionally having a substituent, and
n is 1 or more and 3 or less.

### [X]

X is a direct bond or a 1+n valent group. n may be 1 or more, 2 or more, or 3 or more. n may be 3 or less, 2 or less, or 1 or less, and may be, for example, 1, 2, or 3.
X may have a molecular weight of 3,000 or less, 2,500 or less, 2,000 or less, 1,500 or less, 1,000 or less, 750 or less, or 500 or less. X may have a molecular weight of 10 or more, 50 or more, 100 or more, 200 or more, 300 or more, 500 or more, or 750 or more.
X is a 1+n valent group composed of one or more selected from the group consisting of X¹ and X²,
X¹ is a group composed of one or more selected from the group consisting of a direct bond, —O—, —C(═O)—, —S(═O)₂—, —NR′—, —C(OR′)R′—, and —C(OR′)(—)₂, wherein R′ is independently at each occurrence a hydrogen atom or a hydrocarbon group having 1 to 4 carbon atom, and
X² is a hydrocarbon group having 1 to 40 carbon atoms, wherein n is an integer of 1 or more and 3 or less.
X¹ and X² will be described in the following.

### X¹

X¹ is a non-hydrocarbon linker.
X¹ is a direct bond or a divalent or higher valent group. X¹ may have a valence of 2 to 4, 2 or 3, or 2. It is preferable that X¹ is not limited to direct bond.
X¹ may have a molecular weight of 2,000 or less, 1,500 or less, 1,000 or less, 750 or less, or 500 or less. X¹ may have a molecular weight of 10 or more, 50 or more, 100 or more, 200 or more, 300 or more, or 500 or more.
X¹ is a group composed of one or more selected from the group consisting of a direct bond, —O—, —C(═O)—, —S(═O)₂—, —NR′—, —C(OR′)R′—, and —C(OR′)(—)₂ (wherein R′ is independently at each occurrence a hydrogen atom or a hydrocarbon group having 1 to 4 carbon atom).

Examples of X¹ include
a direct bond,

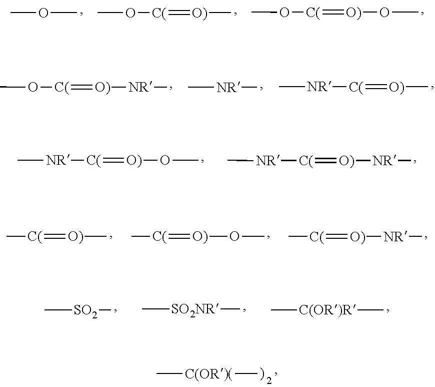

wherein R′ is independently at each occurrence a hydrogen atom or a monovalent organic group.

### X²

X² is a hydrocarbon linker, and a hydrocarbon group having 1 to 40 carbon atoms.
X² is a divalent or higher valent group. X² may have a valence of, for example, 2 to 4, 2 to 3, or 2.
X² may have 1 or more, 2 or more, 3 or more, 4 or more, 6 or more, 8 or more, 10 or more, 12 or more, 14 or more, 16 or more, or 18 or more carbon atoms. X² may have 40 or less, 35 or less, 30 or less, 25 or less, 20 or less, 15 or less, 10 or less, or 5 or less carbon atoms.
X² may be a cyclic, branched, or linear hydrocarbon group. X² may be an aromatic hydrocarbon group or an aliphatic hydrocarbon group, for example, an aliphatic hydrocarbon group (e.g., a saturated aliphatic hydrocarbon group).

Specific examples of X² include:
—(CH₂)ₚ— (wherein p is 1 to 40, for example, 1 to 10),
a linear hydrocarbon group having 1 to 40 carbon atoms and having, for example, 1 to 10 unsaturated bonds,
a hydrocarbon group having 1 to 40 carbon atoms and having, for example, 1 to 10 branched structures, and
—(CH₂)_{q}—(Ar)ₛ—(CH₂)ᵣ— (wherein q and r are each independently 0 to 40, for example, 1 to 10, —Ar— is benzene or naphthalene, the Ar group may have any substituent, and s is an integer of 1 to 3).

The hydrocarbon group in X² may have a substituent, but is preferably non-substituted. Examples of substituents include —OR′, —N(R′)₂, —COOR′, and a halogen atom (wherein R′ is independently at each occurrence a hydrogen atom or a hydrocarbon group having 1 to 30, 1 to 20, 1 to 10, or 1 to 4 carbon atoms). The substituent may or may not have active hydrogen. The number of substituents may be 6 or less, 5 or less, 4 or less, 3 or less, 2 or less, 1 or less, or 0. In the hydrocarbon group having a substituent, the amount of carbon atom relative to the carbon atom and the heteroatom may be 70 mol % or more, 80 mol % or more, 90 mol % or more, 95 mol % or more, or 99 mol % or more, and is preferably 75 mol % or more. In the hydrocarbon group having a substituent, the amount of carbon atom relative to the carbon atom and the heteroatom may be 95 mol % or less, 90 mol % or less, 85 mol % or less, or 80 mol % or less.

### Examples of X

Examples of X will be described. In the following, R′ is independently at each occurrence a hydrogen atom or a hydrocarbon group having 1 to 4 (for example, 1 to 2, or 1) carbon atoms.

Preferred examples of X include —X¹— or —X¹—X²—X¹—.
X is preferably a group represented by —X¹— or —X¹—X²—X¹—
wherein X¹ is independently at each occurrence a direct bond,

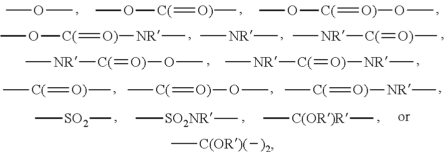

wherein R′ is independently at each occurrence a hydrogen atom or a hydrocarbon group having 1 to 40 (for example, 1 to 20, 1 to 12, 1 to 8, or 1 to 4) carbon atoms, and
X² is a hydrocarbon group having 1 to 40 carbon atoms and optionally having a substituent. By this, excellent liquid-repellency can be imparted to substrates.
X may have an amide group, a urea group, or a urethane group. Examples of such X include groups including

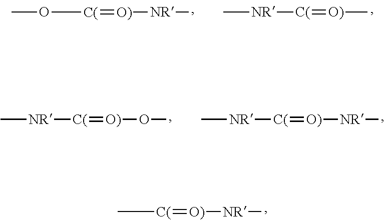

The NR′ group in the amide group, urea group, or urethane group does not need to be adjacent to an aromatic ring.

When X is divalent, examples of X include —X¹—, —X¹—C(═O)—, —C(═O)—X¹—, —X¹—C(═O)—X¹—, —X¹—X²—, —X¹—X²—X¹—, —X¹—X²—X¹—C(═O)—, —X¹—X²—C(═O)—X¹—, —X¹—X²—X¹—C(═O)—X¹—, and —X¹—X²—X¹—X²—.

When X is trivalent, examples of X include —X¹(—)₂, —X¹—X¹(—)₂, —X¹—X²(—X¹—)₂, —X²(—X¹—)₂, —X²(—X¹—C(═O)—)₂, —X²(—C(═O)—X¹—)₂, —X²(—X¹—C(═O)—X¹—)₂, —X²(—X¹—X²—)₂, —X²(—X¹—X²—X¹—)₂, —X²(—X¹—X²—X¹—C(═O)—)₂, —X²(—X¹—X²—C(═O)—X¹—)₂, —X²(—X¹—X²—X¹—C(═O)—X¹—)₂, and —X²(—X¹—X²—X¹—X²—)₂.

When X is tetravalent, examples of X include —X¹—X²(—X¹—)₃, —X²(—X¹—)₃, —X²(—X¹—C(═O)—)₃, —X²(—C(═O)—X¹—)₃, —X²(—X¹—C(═O)—X¹—)₃, —X²(—X¹—X²—)₃, —X²(—X¹—X²—X¹—)₃, —X²(—X¹—X²—X¹—C(═O)—)₃, —X²(—X¹—X²—C(═O)—X¹—)₃, —X²(—X¹—X²—X¹—C(═O)—X¹—)₃, and —X²(—X¹—X²—X¹—X²—)₃.

When X is divalent, specific examples of X include —O—, —O—C(═O)—, —O—C(═O)—O—, —O—C(═O)—NR′—, —O—X²—S(═O)₂—NR′—, —O—X²—NR′—, —O—X²—NR′—S(═O)₂—, —O—X²—NR′—C(═O)—, —O—X²—NR′—C(═O)—O—, —O—X²—NR′—C(═O)—NR′—, —O—X²—NR′—X²—, —O—X²—O—, —O—X²—O—C(═O)—, —O—X²—O—C(═O)—NR′—, —O—X²—C(═O)—O—, —O—X²—C(═O)—NR′—, —O—X²—O—X²—, —O—X²—, —NR′—, —NR′—C(═O)—, —NR′—C(═O)—O—, —NR′—C(═O)—NR′—, —NR′—X²—S(═O)₂—NR′—, —NR′—X²—NR′—, —NR′—X²—NR′—S(═O)₂—, —NR′—X²—NR′—C(═O)—, —NR′—X²—NR′—C(═O)—O—, —NR′—X²—NR′—C(═O)—NR′—, —NR′—X²—NR′—X²—, —NR′—X²—O—, —NR′—X²—O—C(═O)—, —NR′—X²—O—C(═O)—NR′—, —NR′—X²—O—X²—, —NR′—X²—C(═O)—O—, —NR′—X²—C(═O)—NR′—, —NR′—X²—, —C(═O)—, —C(═O)—O—, —C(═O)—NR′—, —C(═O)—S—, —SO₂—, —SO₂NR′—, and —C(OR′)(R′)(—).

When X is trivalent, specific examples of X include —X²(—O—)₂—, —X²(—O—C(═O)—)₂—, —X²(—O—C(═O)—O—)₂—, —X²(—O—C(═O)—NR′—)₂—, —X²(—O—X²—S(═O)₂—NR′—)₂—, —X²(—O—X²—NR′—)₂—, —X²(—O—X²—NR′—S(═O)₂—)₂—, —X²(—O—X²—NR′—C(═O)—)₂—, —X²(—O—X²—NR′—C(═O)—O—)₂—, —X²(—O—X²—NR′—C(═O)—NR′—)₂—, —X²(—O—X²—NR′—X²—)₂—, —X²(—O—X²—O—)₂—, —X²(—O—X²—O—C(═O)—)₂—, —X²(—O—X²—O—C(═O)—NR′—)₂—, —X²(—O—X²—C(═O)—O—)₂—, —X²(—O—X²—C(═O)—NR′—)₂—, —X²(—O—X²—O—X²—)₂—, —X²(—O—X²—)₂—, —X²(—NR′—)₂—, —X²(—NR′—C(═O)—)₂—, —X²(—NR′—C(═O)—O—)₂—, —X²(—NR′—C(═O)—NR′—)₂—, —X²(—NR′—X²—S(═O)₂—NR′—)₂—, —X²(—NR′—X²—NR′—)₂—, —X²(—NR′—X²—NR′—S(═O)₂—)₂—, —X²(—NR′—X²—NR′—C(═O)—)₂—, —X²(—NR′—X²—NR′—C(═O)—O—)₂—, —X²(—NR′—X²—NR′—C(═O)—NR′—)₂—, —X²(—NR′—X²—NR′—X²—)₂—, —X²(—NR′—X²—O—)₂—, —X²(—NR′—X²—O—C(═O)—)₂—, —X²(—NR′—X²—O—C(═O)—NR′—)₂—, —X²(—NR′—X²—O—X²—)₂—, —X²(—NR′—X²—C(═O)—O—)₂—, —X²(—NR′—X²—C(═O)—NR′—)₂—, —X²(—NR′—X²—)₂—, —X²(—C(═O)—)₂—, —X²(—C(═O)—O—)₂—, —X²(—C(═O)—NR′—)₂—, —X²(—C(═O)—S—)₂—, —X²(—SO₂—)₂—, —X²(—SO₂NR′—)₂—, —X²(—C(OR′)(R′)(—))₂—, and —C(OR′)(—)₂.

When X is tetravalent, specific examples of X include —X²(—O—)₃—, —X²(—O—C(═O)—)₃—, —X²(—O—C(═O)—O—)₃—, —X²(—O—C(═O)—NR′—)₃—, —X²(—O—X²—S(═O)₂—NR′—)₃—, —X²(—O—X²—NR′—)₃—, —X²(—O—X²—NR′—S(═O)₂—)₃—, —X²(—O—X²—NR′—C(═O)—)₃—, —X²(—O—X²—NR′—C(═O)—O—)₃—, —X²(—O—X²—NR′—C(═O)—NR′—)₃—, —X²(—O—X²—NR′—X²—)₃—, —X²(—O—X²—O—)₃—, —X²(—O—X²—O—C(═O)—)₃—, —X²(—O—X²—O—C(═O)—NR′—)₃—, —X²(—O—X²—C(═O)—O—)₃—, —X²(—O—X²—C(═O)—NR′—)₃—, —X²(—O—X²—O—X²—)₃—, —X²(—O—X²—)₃—, —X²(—NR′—)₃—, —X²(—NR′—C(═O)—)₃—, —X²(—NR′—C(═O)—O—)₃—, —X²(—NR′—C(═O)—NR′—)₃—, —X²(—NR′—X²—S(═O)₂—NR′—)₃—, —X²(—NR′—X²—NR′—)₃—, —X²(—NR′—X²—NR′—S(═O)₂—)₃—, —X²(—NR′—X²—NR′—C(═O)—)₃—, —X²(—NR′—X²—NR′—C(═O)—O—)₃—, —X²(—NR′—X²—NR′—C(═O)—NR′—)₃—, —X²(—NR′—X²—NR′—X²—)₃—, —X²(—NR′—X²—O—)₃—, —X²(—NR′—X²—O—C(═O)—)₃—, —X²(—NR′—X²—O—C(═O)—NR′—)₃—, —X²(—NR′—X²—O—X²—)₃—, —X²(—NR′—X²—C(═O)—O—)₃—, —X²(—NR′—X²—C(═O)—NR′—)₃—, —X²(—NR′—X²—)₃—, —X²(—C(═O)—)₃—, —X²(—C(═O)—O—)₃—, —X²(—C(═O)—NR′—)₃—, —X²(—C(═O)—S—)₃—, —X²(—SO₂—)₃—, —X²(—SO₂NR′—)₃—, and —X²(—C(OR′)(R′)(—))₃.

### [R]

R is independently at each occurrence an aliphatic hydrocarbon group having 4 or more and 40 or less carbon atoms, having at least one alkylsilyl group, and optionally having a substituent.

### Aliphatic Hydrocarbon Group

The aliphatic hydrocarbon group as R may be a monovalent aliphatic hydrocarbon group having 4 or more and 40 or less carbon atoms. The aliphatic hydrocarbon group may be branched or linear, and more preferably linear. The aliphatic hydrocarbon group may have an unsaturated bond. When the aliphatic hydrocarbon group has an unsaturated bond, the aliphatic hydrocarbon group preferably has two unsaturated bonds, and most preferably one unsaturated bond.

The aliphatic hydrocarbon group as R may have 4 or more, 6 or more, 8 or more, 9 or more, 11 or more, 14 or more, 16 or more, 18 or more, 20 or more, or 22 or more carbon atoms, and preferably 6 or more, 8 or more, 9 or more, or 11 or more carbon atoms. The hydrocarbon group may have 40 or less, 35 or less, 30 or less, 25 or less, 20 or less, 18 or less, 15 or less, 13 or less, 12 or less, 11 or less or 9 or less carbon atoms, preferably 30 or less, 20 or less, 12 or less or 11 or less carbon atoms.

In an embodiment, the aliphatic hydrocarbon group as R has 6 or more and 40 or less carbon atoms.

To the aliphatic hydrocarbon group as R, at least one alkylsilyl group is bonded. To the aliphatic hydrocarbon group as R, 1 or more, 2 or more, 3 or more, 4 or more, 5 or more, 6 or more, 8 or more, 10 or more, 12 or more, 14 or more, 16 or more, or 20 or more alkylsilyl groups may be bonded, and 30 or less, 28 or less, 26 or less, 24 or less, 22 or less, 20 or less, 18 or less, 16 or less, 14 or less, 10 or less, 8 or less, 6 or less, 5 or less, 4 or less, 3 or less, 2 or less or 1 or less alkylsilyl group may be bonded.

The aliphatic hydrocarbon group may have a substituent, but is preferably non-substituted. Examples of substituents include —OR′, —N(R′)₂, —COOR′, and a halogen atom (wherein R′ is independently at each occurrence a hydrogen atom or a hydrocarbon group having 1 to 30, 1 to 20, 1 to 10, or 1 to 4 carbon atoms). The substituent may have or be free of active hydrogen. The number of substituents may be 6 or less, 5 or less, 4 or less, 3 or less, 2 or less, 1 or less, or 0. In the aliphatic hydrocarbon group having a substituent, the amount of carbon atom relative to the amount of carbon atom and heteroatom may be 70 mol % or more, 80 mol % or more, 90 mol % or more, 95 mol % or more, or 99 mol % or more, and is preferably 75 mol % or more. In the aliphatic hydrocarbon group having a substituent, the amount of carbon atom relative to the carbon atom and the heteroatom may be 95 mol % or less, 90 mol % or less, 85 mol % or less, or 80 mol % or less.

### Alkylsilyl Group

The aliphatic hydrocarbon group as R has at least one alkylsilyl group. The alkylsilyl group is represented by the following formula:

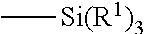

wherein R¹ is each independently a hydrogen atom or an aliphatic hydrocarbon group having 1 to 10 carbon atoms and optionally having a substituent, and at least one R¹ is an aliphatic hydrocarbon group having 1 or more and 10 or less carbon atoms and optionally having a substituent.

The aliphatic hydrocarbon group as R has at least one alkylsilyl group. The aliphatic hydrocarbon group as R may have 1 or more, 2 or more, 3 or more, 4 or more, 5 or more, or 6 or more alkylsilyl groups, and 6 or less, 5 or less, 4 or less, 3 or less, 2 or less, or 1 or less alkylsilyl group.

### R¹

R¹ is each independently a hydrogen atom or an aliphatic hydrocarbon group having 1 to 10 carbon atoms and optionally having a substituent, and at least one R¹ is an aliphatic hydrocarbon group having 1 or more and 10 or less carbon atoms and optionally having a substituent.

Each of the R¹ groups bonded to —Si may be an aliphatic hydrocarbon group having 1 to 10 carbon atoms and optionally having a substituent. This embodiment corresponds to the case that the alkylsilyl group is a trialkylsilyl group.

Two of the R¹ groups bonded to —Si may be each an aliphatic hydrocarbon group having 1 to 10 carbon atoms and optionally having a substituent, and the residual R¹ group may be a hydrogen atom. This embodiment corresponds to the case that the alkylsilyl group is a dialkylsilyl group.

One of the R¹ groups bonded to —Si may be an aliphatic hydrocarbon group having 1 to 10 carbon atoms and optionally having a substituent, and the residual R¹ groups may be each a hydrogen atom. This embodiment corresponds to the case that the alkylsilyl group is a monoalkylsilyl group.

The aliphatic hydrocarbon group as R¹ may be a monovalent aliphatic hydrocarbon group having 1 or more and 10 or less carbon atoms. The aliphatic hydrocarbon group may be branched or linear, and more preferably linear.

The aliphatic hydrocarbon group as R¹ may have 1 or more, 2 or more, 3 or more, 4 or more, or 5 or more carbon atoms, preferably 1 carbon atom. The aliphatic hydrocarbon group may have 10 or less, 9 or less, 8 or less, 7 or less, or 6 or less carbon atoms, preferably 9 or less, 8 or less, or 7 or less carbon atoms.

The aliphatic hydrocarbon group as R¹ may have a substituent, but is preferably non-substituted. Examples of substituents include —OR′, —N(R′)₂, —COOR′, and a halogen atom (wherein R′ is independently at each occurrence a hydrogen atom or a hydrocarbon group having 1 to 30, 1 to 20, 1 to 10, or 1 to 4 carbon atoms). The substituent may or may not have active hydrogen. The number of substituents may be 6 or less, 5 or less, 4 or less, 3 or less, 2 or less, 1 or less, or 0. In the hydrocarbon group having a substituent, the amount of carbon atom relative to the carbon atom and the heteroatom may be 70 mol % or more, 80 mol % or more, 90 mol % or more, 95 mol % or more, or 99 mol % or more, and is preferably 75 mol % or more. In the hydrocarbon group having a substituent, the amount of carbon atom relative to the carbon atom and the heteroatom may be 95 mol % or less, 90 mol % or less, 85 mol % or less, or 80 mol % or less.

### Bonding Position of Alkylsilyl Group

In the Z group represented by —X—Rₙ, R is independently at each occurrence an aliphatic hydrocarbon group having 4 or more and 40 or less carbon atoms, having at least one alkylsilyl group, and optionally having a substituent. The alkylsilyl group may be bonded to a carbon atom constituting the aliphatic hydrocarbon group.

Specifically, when the carbon atom directly bonded to X among the carbon atoms of the aliphatic hydrocarbon group as R is defined to be at position 1, the alkylsilyl group may be bonded to any carbon atom at position 1 to the end.

While the aliphatic hydrocarbon group having 4 or more and 40 or less carbon atoms, which is represented as R, is bonded to the group represented as X in —X—Rₙ, the bonding position of the alkylsilyl group in the aliphatic hydrocarbon group is preferably a carbon atom in proximity to the group represented as X. When the alkylsilyl group is bonded to a carbon atom in proximity to the group represented as X, the water- and oil-repellency to be imparted to a substrate by the liquid-repellent compound can be improved.

When the carbon atom directly bonded to X among the carbon atoms of the aliphatic hydrocarbon group as R is defined to be at position 1, the alkylsilyl group may be bonded to at least one carbon atom at position 1 to position N/2,
wherein N is the number of carbon atoms that a main chain or the longest carbon chain of the aliphatic hydrocarbon group as R has.
When the carbon atom directly bonded to X among the carbon atoms of the aliphatic hydrocarbon group as R is defined to be at position 1, the alkylsilyl group may be bonded to at least one carbon atom at position 1 to position N/2, position 1 to position N/3, position 1 to position N/4, or position 1 to position N/5.

The alkylsilyl group in the aliphatic hydrocarbon group may be bonded to a carbon atom at position 1 or more, position 2 or more, position 4 or more, position 6 or more, position 8 or more, position 10 or more, or position 11 or more. The alkylsilyl group in the aliphatic hydrocarbon group may be bonded to a carbon atom at position 40 or less, position 35 or less, position 30 or less, position 25 or less, position 20 or less, position 15 or less, or position 10 or less, preferably at position 30 or less, position 25 or less, or position 20 or less. For example, the alkylsilyl group in the aliphatic hydrocarbon group may be bonded to a carbon atom at position 1, position 2, position 4, position 6, position 8, position 10, or position 11.
n in Rₙ is the number of R bonded to X, and may be 1 or more, 2 or more, or 3 or more. n may be 3 or less, 2 or less, or 1 or less, and may be, for example, 1, 2, or 3.
N is the number of carbon atoms that a main chain of the aliphatic hydrocarbon group as R has.

### {Specific Examples of Liquid-Repellent Compound}

Specific examples of the liquid-repellent compound in the present disclosure will be described in the following.

The liquid-repellent compound in the present disclosure may be a compound formed by modifying at least one selected from the group consisting of a polycarboxylic acid, a polyol, a polyamine, an aromatic compound, a nitrogen-containing cyclic compound, an isocyanate derivative, and derivatives thereof, with the Z group.

A derivative is a compound, for example, formed by replacing an active hydrogen that any of a carboxyl group, a hydroxyl group, and an amino group has with another atom or substituent or the like. Examples of such derivatives include halides and acid anhydrides.

### Polycarboxylic Acid

The polycarboxylic acid is a compound having two or more carboxyl groups in the molecule. The polycarboxylic acid may be a low molecular weight compound (having a weight average molecular weight of, for example, less than 1,000 or 500 or less) and/or a high molecular weight compound. The polycarboxylic acid may have a weight average molecular weight of 30 or more, 50 or more, 100 or more, 300 or more, 500 or more, 1,000 or more, 3,000 or more, 5,000 or more, 10,000 or more, 30,000 or more, 100,000 or more, 300,000 or more, or 500,000 or more, and 1,000,000 or less, 7,500,000 or less, 500,000 or less, 3,000,000 or less, 100,000 or less, 75,000 or less, 50,000 or less, 30,000 or less, 10,000 or less, 5,000 or less, 3,000 or less, 2,000 or less, 1,000 or less, or 500 or less.

The polycarboxylic acid may have 2 or more, 5 or more, 7 or more, 10 or more, 15 or more, 30 or more, 50 or more, or 100 or more carboxyl groups, and 3,000 or less, 1,000 or less, 750 or less, 500 or less, 300 or less, 100 or less, 50 or less, 30 or less, or 20 or less carboxyl groups.

The polycarboxylic acid may be at least one selected from the group consisting of a dicarboxylic acid, a tricarboxylic acid, a tetracarboxylic acid, a polymer of a carboxyl group-containing compound, and salts of them.

The dicarboxylic acid is a compound having two carboxyl groups, and examples thereof include oxalic acid, malonic acid, succinic acid, maleic acid, fumaric acid, adipic acid, phthalic acid, terephthalic acid, malic acid, tartaric acid, aldaric acid, and salts thereof.

The tricarboxylic acid is a compound having three carboxyl groups, and examples thereof include citric acid, tricarballylic acid, t-aconitic acid, trimellitic acid, and salts thereof.

The tetracarboxylic acid is a compound having four carboxyl groups, and examples thereof include pyromellitic acid and salts thereof.

The polymer of a carboxyl group-containing compound is a compound having five or more carboxyl groups, and examples thereof include alginic acid, gum tragacanth, gum arabic, polyacrylic acid, polymethacrylic acid, polymaleic acid, polyaspartic acid, polyglutamic acid, hyaluronic acid, heparin, xanthan gum, gellan gum, carboxymethylcellulose alginate, galacturonic acid, mannuronic acid and salts thereof.

The polycarboxylic acid is preferably polyacrylic acid, polymethacrylic acid, or citric acid.

In an embodiment, the liquid-repellent compound is a compound formed by replacing hydroxy groups of one or more carboxyl groups of a polycarboxylic acid each with the Z group, and
the polycarboxylic acid may be at least one selected from the group consisting of a dicarboxylic acid, a tricarboxylic acid, a tetracarboxylic acid and a polymer of a carboxyl group-containing compound.

The polycarboxylic acid is preferably at least one selected from the group consisting of:
citric acid, malic acid, glutaric acid, adipic acid, phthalic acid, alginic acid, tartaric acid, oxalic acid, malonic acid, succinic acid, fumaric acid, maleic acid, aldaric acid;
tricarballylic acid, t-aconitic acid, trimellitic acid;
pyromellitic acid and derivatives thereof.

The Z group is as described above.

### Polyol

The polyol is a compound having two or more hydroxyl groups in the molecule. The polyol may be a low molecular weight compound (having a weight average molecular weight of, for example, less than 1,000 or 500 or less) and/or a high molecular weight compound. The polyol may have a weight average molecular weight of 30 or more, 50 or more, 100 or more, 300 or more, 500 or more, 1,000 or more, 3,000 or more, 5,000 or more, 10,000 or more, 30,000 or more, 100,000 or more, 300,000 or more, or 500,000 or more, and 1,000,000 or less, 750,0000 or less, 500,000 or less, 3,000,000 or less, 100,000 or less, 75,000 or less, 50,000 or less, 30,000 or less, 10,000 or less, 5,000 or less, 3,000 or less, 2,000 or less, 1,000 or less, or 500 or less.

The polyol may have 2 or more, 5 or more, 7 or more, 10 or more, 15 or more, 30 or more, 50 or more, or 100 or more hydroxyl groups, and 3,000 or less, 1,000 or less, 750 or less, 500 or less, 300 or less, 100 or less, 50 or less, 30 or less, or 20 or less hydroxyl groups.

Examples of polyol include a monosaccharide, an oligosaccharide, a polysaccharide, a sugar alcohol (reducing sugar), a hydroxy acid, an amino acid, vitamin, flavonol, hydroxyhydrocarbon, a polymer of a hydroxy group-containing compound, polyether polyol, polymer polyol, polyester polyol and other polyols.

Examples of monosaccharides include glucose, fructose, galactose and xylose.

Examples of oligosaccharides include sucrose, cycloamylose, cyclodextrin, maltose, trehalose, lactose and sucralose.

Examples of sugar alcohols (reducing sugar) include sorbitol, maltitol, erythritol, isomalt, lactitol, mannitol, xylitol, sorbitan and lactitol.

Examples of polysaccharides include starch, cellulose, curdlan, pullulan, alginic acid, carrageenan, guar gum, chitin, chitosan, locust bean gum, kappa-carrageenan, iota-carrageenan, isomaltodextrin, gellan gum, tamarind seed gum, and sterol.

Examples of hydroxy acids include ascorbic acid, kojic acid, quinic acid, chlorogenic acid and gluconic acid.

Examples of amino acids include glucosamine.

Examples of vitamins include ascorbic acid and inositol.

Examples of flavonols include catechin, quercetin and anthocyanin.

Examples of hydroxyhydrocarbons include ethylene glycol, propylene glycol, diethylene glycol, triethylene glycol, tetraethylene glycol, neopentyl glycol, trimethylene glycol, monoglycerol, trimethylolpropane and trimethylolethane. The hydroxyhydrocarbons are a hydrocarbon having a hydroxy group, and may be aliphatic or aromatic, and is preferably aliphatic. The term “hydroxyhydrocarbon” may also mean hydroxyhydrocarbons other than the compounds included in a different group, such as polysaccharide (other hydroxyhydrocarbons).

Examples of polymers of a hydroxy group-containing compound include polyglycerol, polyvinyl alcohol, hydroxyethyl (meth)acrylate polymer, hydroxypropyl (meth)acrylate polymer and hydroxybutyl (meth)acrylate polymer.

Polyether polyol may be a compound obtained by addition polymerization of alkylene oxide onto an initiator. Examples of initiators include a bifunctional or higher functional compound having a hydroxy group. Examples of initiators include propylene glycol, polypropylene glycol, ethylene glycol, polyethylene glycol, glycerol, polyglycerol, trimethylol propane, triethanolamine, pentaerythritol, ethylenediamine, aromatic diamine, diethylenetriamine, sorbitol and sucrose. Alkylene oxide include ethylene oxide and propylene oxide. The polyether polyol, which is obtained by addition polymerization of alkylene oxide onto the initiator, is also referred to as polyoxyalkylene polyol, or an oxyalkylene derivative of polyol. Examples of polyether polyol include polyoxypropylene triol obtained by addition polymerization of propylene oxide onto glycerol and polyoxypropylene polyglyceryl ether obtained by addition polymerization of propylene oxide onto polyglycerol.

An example of polymer polyol is a compound obtained by polymerizing at least a moiety of polyether polyol in the polyether polyol with an ethylenically unsaturated monomer. Examples of ethylenically unsaturated monomers include acrylonitrile and styrene.

An example of polyester polyol may be a compound obtained by dehydration condensation of a difunctional or higher functional compound having a carboxyl group and a difunctional or higher functional compound having a hydroxy group. Examples of difunctional or higher functional compounds having a carboxyl group include terephthalic acid, isophthalic acid, phthalic acid, methylphthalic acid, trimellitic acid, pyromellitic acid, adipic acid, sebacic acid, succinic acid, maleic acid, fumaric acid, tetrahydrophthalic acid, methyltetrahydrophthalic acid, hexahydrophthalic acid and an acid anhydride thereof. Examples of difunctional or higher functional compounds having a hydroxy group include ethylene glycol, propylene glycol, propanediol, neopentyl glycol, glycerol, trimethylolethane, trimethylolpropane, pentaerythritol and a polymer thereof.

The polyol is preferably starch, cellulose, pullulan, sorbitol, sterol, monoglycerol, polyglycerol, or polyvinyl alcohol, and particularly preferably sorbitol, monoglycerol, polyglycerol, or polyvinyl alcohol.

In an embodiment, the liquid-repellent compound is a compound formed by replacing one or more hydroxy groups of a polyol each with the Z group, and the polyol may be a compound formed by modifying at least one compound selected from a monosaccharide, an oligosaccharide, a polysaccharide, a sugar alcohol, a hydroxy acid, an amino acid, a vitamin, a flavonol, a hydroxyhydrocarbon, and a polymer of a hydroxy group-containing compound, with the Z group.

The polyol is preferably at least one selected from the group consisting of:
glucose, fructose, galactose, xylose;
sucrose, cycloamylose, cyclodextrin, maltose, trehalose, lactose, sucralose;
sorbitol, maltitol, erythritol, isomalt, lactitol, mannitol, xylitol, sorbitan, lactitol;
starch, cellulose, curdlan, pullulan, alginic acid, carrageenan, guar gum, chitin, chitosan, locust bean gum, kappa-carrageenan, iota-carrageenan, isomaltodextrin, gellan gum, tamarind seed gum;
kojic acid, quinic acid, chlorogenic acid, gluconic acid, aldonic acid, uronic acid;
glucosamine;
ascorbic acid, inositol;
catechin, quercetin, anthocyanin;
glycerol, ethylene glycol, propylene glycol, diethylene glycol, triethylene glycol, tetraethylene glycol, neopentyl glycol, trimethylene glycol, trimethylolpropane, trimethylolethane; and
polyglycerol, polyvinyl alcohol, hydroxyethyl (meth)acrylate polymer, hydroxypropyl (meth)acrylate polymer, and hydroxybutyl (meth)acrylate polymer and derivatives thereof.

The Z group is as described above.

### Polyamine

The polyamine is a compound having two or more amino groups in the molecule. The polyamine may be a low molecular weight compound (having a weight average molecular weight of, for example, less than 1,000 or 500 or less) and/or a high molecular weight compound. The polyamine may have a weight average molecular weight of 30 or more, 50 or more, 100 or more, 300 or more, 500 or more, 1,000 or more, 3,000 or more, 5,000 or more, 10,000 or more, 30,000 or more, 100,000 or more, 300,000 or more, or 500,000 or more, and 1,000,000 or less, 7,500,000 or less, 500,000 or less, 3,000,000 or less, 100,000 or less, 75,000 or less, 50,000 or less, 30,000 or less, 10,000 or less, 5,000 or less, 3,000 or less, 2,000 or less, 1,000 or less, or 500 or less.

The polyamine has one or more amino groups. The amino group is a mono to trivalent amino group and is one or more groups selected from the group consisting of —NH₂, —NH— and —N(—)₂. The polyamine may have 2 or more, 3 or more, 4 or more, 5 or more, or 6 or more, and preferably 2 or more, and 12 or less, 10 or less, 8 or less, 6 or less, 4 or less, or 3 or less amino group.

The polyamine may have a hydrocarbon group (an aliphatic hydrocarbon group or an aromatic hydrocarbon group). The hydrocarbon group may be cyclic, branched or linear. The hydrocarbon group may be saturated or unsaturated (for example, saturated). In this case, the hydrocarbon group may be interrupted by an oxygen atom and/or sulfur atom, and may be composed of only a carbon atom, a nitrogen atom and a hydrogen atom. The hydrocarbon group may be a hydrocarbon group optionally interrupted by an oxygen atom and/or a sulfur atom (e.g., a chain saturated aliphatic hydrocarbon group or an aromatic hydrocarbon group having 1 or 2 hydrocarbon aromatic rings), a usual hydrocarbon group (e.g., a chain saturated aliphatic hydrocarbon group or an aromatic hydrocarbon group having 1 or 2 hydrocarbon aromatic rings). When the hydrocarbon group is interrupted by an oxygen atom and/or a sulfur atom, the amine backbone has an ether, thioether, polyether or polythioether structure. The amine backbone may have 1 or more, 2 or more, 3 or more, 4 or more, 5 or more, or 6 or more, and 12 or less, 10 or less, 8 or less, 6 or less, 4 or less, 3 or less, 2 or less, or 1 hydrocarbon group.

The polyamine may be composed of mono to trivalent amino group and a chain saturated aliphatic hydrocarbon group or aromatic hydrocarbon group optionally interrupted by an oxygen atom and/or a sulfur atom.

The mole ratio between the carbon atom and the nitrogen atom (C/N ratio) in the polyamine may be 1 or more, 2 or more, 2.5 or more, 3 or more, 3.5 or more, or 4 or more, and 8 or less, 7 or less, 6 or less, 5 or less, 4 or less, 3.5 or less, 3 or less, 2.5 or less, or 2 or less, and preferably 6 or less or 4 or less.

Examples of polyamine include alkylenediamine such as ethylenediamine, propylenediamine, butylenediamine, pentanediamine, hexamethylenediamine, cyclohexanediamine and methylenebiscyclohexylamine; polyalkylenepolyamine such as diethylenetriamine, triethylenetetramine, tris (2-aminoethyl) amine, tetraethylenepentamine, pentaethylenehexamine, dipropylenetriamine, tripropylenetetramine, tris(2-aminopropyl) amine, tetrapropylenepentamine, pentapropylenehexamine, iminobispropylamine, dibutylenetriamine, bis(2-aminoethoxy)ethane, bis(2-aminoethyl)ether, bis [2-(2-aminoethoxy)ethyl] ether, bis[2-(3-aminopropoxy)ethyl] ether, spermine and spermidine; oxygen or sulfur-containing aliphatic amine such as polyoxypropylenediamine and polyoxyethylenediamine; monocyclic aromatic polyamine such as o-, m- or p-phenylene diamine, o-, m- or p-xylylenediamine, diaminotoluene and 2,3-, 2,4- or 2,5-tolylenediamine; polycyclic aromatic polyamine such as diaminobiphenyl, bisaminophenoxyphenylpropane, diaminodiphenyl ether, diaminodiphenyl sulfide, diaminodiphenylsulfone, diaminobenzophenone, diaminodiphenylmethane, diaminophenylpropane, diaminophenyl hexafluoropropane, diaminophenylphenylethane, bisaminophenoxybenzene, bisaminobenzoyl benzene, bisaminodimethylbenzyl benzene, aminophenoxybiphenyl, aminophenoxyphenyl ketone, bisaminoditrifluoromethylbenzyl benzene, aminophenoxyphenyl sulfone, aminophenoxyphenyl ether, aminophenoxyphenyl propane, bis(aminophenoxybenzoyl) benzene, bis(aminophenoxy-α,α-dimethylbenzyl) benzene, bis[(aminoaryloxy)benzoyl] diphenylether, bis (amino-α,α-dimethylbenzylphenoxy) benzophenone, aminophenoxyphenyl sulfide, bis [amino-α,α-dimethylbenzylphenoxy]diphenyl sulfone, 4,4′-bis[aminophenoxyphenoxy]diphenyl sulfone, diaminodiaryloxybenzophenone, diaminoaryloxybenzophenone, 3,3′-dimethoxy-4,4′-diaminobiphenyl, 4,4′-diaminotriphenyl methane, 3,3′-dimethyl-4,4′-diaminobiphenyl, 4,4′-methylenebisaniline, 4,4′-oxydianiline, 1,3-bis(4-aminophenoxy)benzene, 4,4′-diaminodiphenylether and 4,4′-bis(aminophenyl)amine; oxygen or sulfur-containing polycyclic aromatic polyamine such as 2,2′-bis[4-(4-aminophenoxy)phenyl]propane, 1,3-bis(4-aminophenoxy)benzene, 1,3-bis(3-aminophenoxy)benzene, 3,4′-diaminodiphenyl ether and 4,4′-diaminodiphenylsulfide; and hydroxyl group-containing polyamine such as 2-hydroxyethylethylenediamine, 2-hydroxyethylpropylenediamine, di-2-hydroxyethylethylenediamine, di-2-hydroxyethylpropylenediamine, 2-hydroxypropylethylenediamine and di-2-hydroxypropylethylenediamine.

Examples of the polyamine include ethylenediamine, propylenediamine, butylenediamine, trimethylhexamethylenediamine, 1,2-diaminopropane, diethylenetriamine, triethylenetetramine, propylenediamine, hexamethylenediamine, o-phenylenediamine, m-phenylenediamine, p-phenylenediamine, diaminodiphenylmethane, diaminodiphenyl sulfone, diamino diphenyl ether, 2,4- (or m-, o-) tolylenediamine, m-aminobenzylamine, benzidine, bis(3,4-diaminophenyl) sulfone, diaminonaphthalene, 2,4-diamino-1,3,5-triazine, piperazine, N-aminoethylpiperazine cyclen, spermine, polyethyleneimine, polypropyleneamine, polyvinylamine, polyallylamine, polyether amine, poly-L-lysine, poly-L-ornithine, POLYMENT® (aminoethylated acrylic polymer) and derivatives thereof.

The polyamine is preferably ethylenediamine, hexamethylenediamine, p-phenylenediamine, polyethyleneimine, or POLYMENT® (aminoethylated acrylic polymer), and particularly preferably ethylenediamine, hexamethylenediamine, or p-phenylenediamine.

In an embodiment, the liquid-repellent compound is a compound formed by replacing hydrogen atoms bonded to one or more nitrogen atoms of a polyamine each with the Z group, and
the polyamine may be composed of a mono to trivalent amino group and a chain saturated aliphatic hydrocarbon group or aromatic hydrocarbon group optionally interrupted by an oxygen atom and/or a sulfur atom, with the mole ratio between carbon atom and nitrogen atom (C/N ratio) being 8 or less.

The Z group is as described above.

### Aromatic Compound and Nitrogen-Containing Cyclic Compound

Examples of the aromatic compound include benzene, biphenyl, naphthalene, anthracene, phenanthrene, tetracene, pentacene, pyrene, and coronene. The number of ring constituting atom of the aromatic compound is 3 to 20, 4 to 16, or 5 to 12, and preferably 5 to 12.

Examples of the nitrogen-containing cyclic compound include pyrrole, pyridine, pyrazine, pyrimidine, pyridazine, diazine, oxazine, thiazine, triazine, tetrazine, quinoline, quinoxaline, quinazoline, phthalazine, cinnoline, isoquinoline, pteridine, acridine, phenazine, phenanthroline, tetrazole, pyrazole, imidazole, thiazole, oxazole, indazole, benzimidazole, benzotriazole, benzoxazole, benzothiazole, carbazole, purine, triazolopyridazine, triazolopyrimidine, tetrazaindene, oxadiazole, imidazopyridine, pyrrolopyridine, thiadiazolopyridine, azepine, diazepine, thiazepine, dibenzazepine, and tribenzazepine. The total number of atoms of ring constituting carbon atom and nitrogen atom of the nitrogen-containing cyclic compound is 3 to 20, 4 to 16, or 5 to 12, and preferably 5 to 12.

In an embodiment, the liquid-repellent compound may be a compound represented by the following formula:

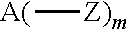

wherein A is an m valent group obtained by removing m hydrogen atoms from an aromatic ring having 7 or more carbon atoms or a nitrogen-containing cyclic compound having 5 or more carbon atoms, with the aromatic ring or nitrogen-containing cyclic compound optionally having a substituent.

A is an m valent group obtained by removing m hydrogen atoms from an aromatic ring having 7 or more carbon atoms or a nitrogen-containing cyclic compound having 5 or more carbon atoms, with the aromatic ring or nitrogen-containing cyclic compound optionally having a substituent. m may be 1 or more, 2 or more, 3 or more, 4 or more, or 5 or more, preferably 2 or more (e.g., 3 or more). m may be 6 or less, 5 or less, 4 or less, 3 or less, or 2 or less, preferably 4 or less.

Examples of the aromatic compound having 7 or more carbon atoms include naphthalene, anthracene, phenanthrene, tetracene, pentacene, pyrene, and coronene.

Examples of the nitrogen-containing cyclic compound having 5 or more carbon atoms include pyridine, quinoline, quinoxaline, quinazoline, phthalazine, cinnoline, isoquinoline, pteridine, acridine, phenazine, phenanthroline, benzimidazole, benzotriazole, benzoxazole, benzothiazole, carbazole, purine, triazolopyridazine, triazolopyrimidine, tetrazaindene, imidazopyridine, pyrrolopyridine, thiadiazolopyridine, azepine, diazepine, thiazepine, dibenzazepine, and tribenzazepine.

The aromatic compound or nitrogen-containing cyclic compound may have a substituent. Examples of the substituent of the aromatic compound or nitrogen-containing cyclic compound include, but are not limited to, one or more groups selected from —OR′, —N(R′)₂, —COOR′ (wherein R′ is a hydrogen atom or a hydrocarbon group having 1 to 4 carbon atoms), a halogen atom, and a C₁₋₆ alkyl group, C₂₋₆ alkenyl group, C₂₋₆ alkynyl group, C₃₋₁₀ cycloalkyl group, C₃₋₁₀ unsaturated cycloalkyl group, 5- to 10-membered heterocyclyl group, 5- to 10-membered unsaturated heterocyclyl group, C₆₋₁₀ aryl group, and 5- to 10-membered heteroaryl group optionally substituted with one or more halogen atoms.

The aromatic compound or nitrogen-containing heterocyclic ring may be a 4-membered ring, a 5-membered ring, a 6-membered ring, a 7-membered ring, or an 8-membered ring. The aromatic compound or nitrogen-containing heterocyclic ring may be a fused polycyclic ring containing 2 to 5 (preferably 2 to 3) 4- to 8-membered rings.

The aromatic compound may have 7 or more, 8 or more, or 10 or more carbon atoms. The hydrocarbon aromatic compound may have 30 or less, 20 or less, 16 or less, 12 or more, or 8 or less carbon atoms.

The aromatic compound may be a fused polycyclic ring containing a plurality of (e.g., 2 to 5, preferably 2 to 3) aromatic ring and/or non-aromatic hydrocarbons.

The nitrogen-containing heterocyclic ring may have 5 or more, 6 or more, 8 or more, or 10 or more carbon atoms. The nitrogen-containing cyclic compound may have 30 or less, 20 or less, 16 or less, 12 or more, or 8 or less carbon atoms.

The compound in the present disclosure may be a polymer (e.g., a condensed product or a crosslinked product) of the aromatic compound or nitrogen-containing cyclic compound. For the polymer, polymerization may proceed via the substituent that A has.

A known method to proceed polymerization on the functional group that A has can be used for condensation reaction or cross-linking reaction for obtaining the polymer without limitation, and a known catalyst, dehydration condensation agent, cross-linking agent, or the like may be used. Examples of the catalyst, dehydration condensation agent, and cross-linking agent to be used include: acids such as p-toluenesulfonic acid, acetic acid, trifluoroacetic acid, hydrochloric acid, sulfuric acid, and fluoroboric acid; acid halides such as acetic chloride, propionic chloride, and benzoic chloride; bases such as sodium methoxide, potassium tert-butoxide, sodium hydride, potassium carbonate, cesium carbonate, triethylamine, and diisopropylamine; condensing agents such as tetrabutylammonium bromide, sodium acetate, Burgess reagent, N,N′-dicyclohexylcarbodiimide, 1-ethyl-3-(3-dimethylaminopropyl) carbodiimide (WSC) or a hydrochloride thereof, N,N′-carbonyldiimidazole, 1H-benzotriazol-1-yloxytris(dimethylamino)phosphonium hexafluorophosphate (BOP), O-(7-azabenzotriazol-1-yl)-1,1,3,3-tetramethyluronium hexafluorophosphate (HATU), 2-chloro-1,3-dimethylimidazolium chloride, bromotripyrrolidinophosphonium hexafluorophosphate (PyBrop), diethyl phosphorocyanidate (DEPC), diphenylphosphoryl azide (DPPA), and 4-(4,6-dimethoxy[1,3,5]triazin-2-yl)-4-methylmorpholinium chloride (DMTMM); and Lawesson's reagent.

The Z group is as described above.

### Isocyanate Derivative

The isocyanate derivative is a compound as a reaction product of an isocyanate group-containing compound and an isocyanate-reactive compound. The isocyanate derivative has a moiety derived from an isocyanate-reactive compound and a moiety derived from an isocyanate group-containing compound. It should be noted that, in contrast to isocyanate-based curing agents, the isocyanate derivative normally has no isocyanate group.

### Isocyanate Group-Containing Compound

The isocyanate group-containing compound has an isocyanate group. Examples of the isocyanate group-containing compound include isocyanates, diisocyanates, triisocyanates, and highly functional isocyanates including polymer isocyanates. They may be aliphatic (including alicyclic) or cyclic (including aromatic).

Examples of the isocyanate group-containing compound include the followings.

Examples of diisocyanates include: alicyclic diisocyanates such as 4,4′-methylenediphenylene diisocyanate (MDI), 2,4-toluene diisocyanate, 2,6-toluene diisocyanate, o-, m-, and p-xylylene diisocyanate, 4,4′-diisocyanatodiphenyl ether, 3,3′-dichloro-4,4′-diisocyanatodiphenylmethane, 4,4′-diphenyldiisocyanate, 4,4′-diisocyanatodibenzyl, 3,3′-dimethoxy-4,4′-diisocyanatodiphenyl, 3,3′-dimethyl-4,4′-diisocyanatodiphenyl, 2,2′-dichloro-5,5′-dimethoxy-4,4′-diisocyanatodiphenyl, 1,3-diisocyanatobenzene, 1,2-naphthylene diisocyanate, 4-chloro-1,2-naphthylene diisocyanate, 1,3-naphthylene diisocyanate, 1,8-dinitro-2,7-naphthylene diisocyanate, and 3-isocyanatomethyl-3,5,5-trimethylcyclohexyl isocyanate; aliphatic diisocyanates such as 3-isocyanatomethyl-3,5,5-trimethylcyclohexyl isocyanate, 1,6-hexamethylene diisocyanate, 2,2,4-trimethyl-1,6-hexamethylene diisocyanate, and 1,2-ethylene diisocyanate; and cyclic diisocyanates such as isophorone diisocyanate (IPDI) and dicyclohexylmethane-4,4′-diisocyanate.

Examples of triisocyanates include aliphatic triisocyanates such as 1,3,6-hexamethylene triisocyanate, and aromatic triisocyanates such as tri-(4-isocyanatophenyl)-methane.

Examples of polymer isocyanates include polymethylene polyphenyl isocyanate (PAPI).

### Isocyanate-Reactive Compound

The isocyanate-reactive compound is a compound containing a isocyanate-reactive group, and examples thereof include monofunctional, bifunctional, and polyfunctional alcohols, thiols, and amines. Examples of the isocyanate-reactive compound include: an alkanol such as methanol, ethanol, n-propyl alcohol, isopropyl alcohol, n-butyl alcohol, isobutyl alcohol, t-butyl alcohol, n-amyl alcohol, t-amyl alcohol, 2-ethylhexanol, glycidol, (iso) stearyl alcohol, and behenyl alcohol, and a linear or branched long-chain alkanol such as an alkyl alcohol having a C6 to C40 alkyl chain; and an alcohol containing a poly(oxyalkylene) group such as methyl or ethyl ether of polyethylene glycol, and hydroxy-terminus methyl or ethyl ether of random or block copolymer between ethylene oxide and/or propylene oxide and polysiloxane (e.g., polydimethylsiloxane) group-containing alcohol. Further examples include a diol, triol, and polyol such as 1,4-butanediol, 1,6-hexanediol, 1-10-decanediol, 4,4′-isopropylidenediphenol (bisphenol A), glycerol, pentaerythritol, and dipentaerythritol, polycaprolactonediol, a fatty acid dimer diol, and a poly(oxy)alkylenediol having an oxyalkylene group having 2 to 4 carbon atoms such as —OCH₂CH₂—, —O(CH₂)₄—, —OCH₂CH₂CH₂—, —OCH(CH₃)CH₂—, and —OCH(CH₃)CH(CH₃)— (oxyalkylene units in the poly(oxyalkylene) may be the same as for polypropylene glycol or present as a mixture), and an ester diol such as glycerol monostearate and polysiloxane-containing diols (e.g., polydimethylsiloxane-containing diol). Examples of the isocyanate-reactive compound include an amine-containing compound such as octadecylamine, di(octadecyl)amine, and 1,6-hexamethylenediamine, terminal-aminated polyethylene oxide or propylene oxide or copolymer thereof, terminal-aminated methyl or ethyl ether of polyethylene oxide or propylene oxide or copolymer thereof, and polysiloxane terminal-treated with an amino group such as polydimethylsiloxane.

The isocyanate-reactive compound for the isocyanate derivative preferably has the Z group in addition to the isocyanate-reactive group.

The isocyanate derivative may be a polymer formed through continuous reaction of isocyanate and the isocyanate-reactive compound.

In an embodiment, the liquid-repellent compound is a compound formed by modifying an isocyanate derivative with the Z group, and the isocyanate derivative may be a polyurethane obtained by reacting an isocyanate group-containing compound and an isocyanate-reactive compound.

The isocyanate group-containing compound is preferably a triisocyanate.

The isocyanate derivative may be a compound containing the Z group and represented by the following formula:

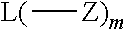

wherein L is an m valent urethan/amide backbone as a reaction product of
(a) one or more isocyanate group-containing compounds selected from the group consisting of isocyanate, diisocyanate, and polyisocyanate, and
(b) one or more isocyanate-reactive compounds selected from the group consisting of compounds represented by formulae (2a), (2b), and (2c) shown below, and
m is 1 or more and 6 or less.

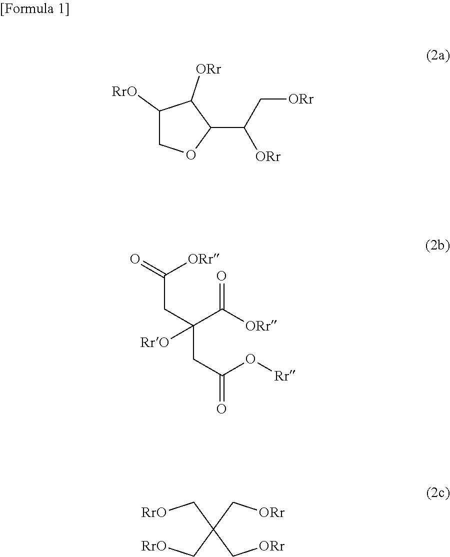

In the general formulae (2a) and (2c):
Rr is independently at each occurrence —H, -*, —C(O)—*, —(CH₂CH₂O)ₚ(CH(CH₃)CH₂O)_{q}H, —(CH₂CH₂O)ₚ(CH(CH₃)CH₂O)_{q}—*, or —(CH₂CH₂O)ₚ(CH(CH₃)CH₂O)_{q}C(O)—*,
p is independently at each occurrence 0 to 20,
q is independently at each occurrence 0 to 20,
p+q is more than 0, and
the symbol * is a bond to L,
provided that when the isocyanate-reactive compound is represented by the general formula (2a) or (2c), at least one of the Rr groups is —H or —(CH₂CH₂O)ₚ(CH(CH₃)CH₂O)_{q}H and at least one of the other Rr groups is -*, —C(O)—*, —(CH₂CH₂O)ₚ(CH(CH₃)CH₂O)_{q}—*, or —(CH₂CH₂O)ₚ(CH(CH₃)CH₂O)_{q}C(O)—*.

In the general formula (2b):
Rr′ is independently at each occurrence —H, -*, —C(O)—*, —(CH₂CH₂O)_{p′}(CH(CH₃)CH₂O)_{q′}H, —(CH₂CH₂O)_{p′}(CH(CH₃)CH₂O)_{q′}—*, or —(CH₂CH₂O)_{p′}(CH(CH₃)CH₂O)_{q′}C(O)—*,
Rr″ is independently at each occurrence —H, -*, —(CH₂CH₂O)_{p′}(CH(CH₃)CH₂O)_{q′}H, —(CH₂CH₂O)_{p′}(CH(CH₃)CH₂O)_{q′}—*, or —(CH₂CH₂O)_{p′}(CH(CH₃)CH₂O)_{q′}C(O)—*,
p′ is independently at each occurrence 0 to 20,
q′ is independently at each occurrence 0 to 20,
p′+q′ is more than 0, and
the symbol * is a bond to L,
provided that when the isocyanate-reactive compound is represented by the general formula (2b), at least one of the Rr′ and Rr″ groups is —H or —(CH₂CH₂O)_{p′}(CH(CH₃)CH₂O)_{q′}H and at least one of the other Rr′ and Rr″ groups is -*, —C(O)—*, —(CH₂CH₂O)_{p′}(CH(CH₃)CH₂O)_{q′}—*, or —(CH₂CH₂O)_{p′}(CH(CH₃)CH₂O)_{q′}C(O)—*.
p, q, p′, and q′ are each an integer of 0 to 20 in the case of only one isocyanate derivative, and can be represented as an average value in the case of a collective form of a plurality of isocyanate derivatives.

In this case, L in the isocyanate derivative is a urethane backbone prepared through a process including reacting an isocyanate group-containing compound (a) and an isocyanate-reactive compound (b), and such a urethane/amide backbone can be normally polyvalent, but L is not limited thereto. When the isocyanate-reactive compound (b) is represented by the general formula (2a) or (2c), the isocyanate-reactive compound has at least one —OH group; when the isocyanate-reactive compound (b) is represented by the general formula (2b), the isocyanate-reactive compound has at least one-OH group or —COOH group. Accordingly, by reacting an isocyanate group-containing compound (a) and an isocyanate-reactive compound (b), a reaction product in which they are bonded via a urethane bond or an amide bond can be obtained. This reaction is known, and can be performed under any proper conditions.

In the isocyanate derivative, —X—Rₙ of the Z group is connected to each of the m bonds (represented as the symbol *) present in the moiety derived from the isocyanate-reactive compound (b) (X is connected to the bond of L). The moiety “—X—Rₙ” of the Z group is connected to the bond (represented as the symbol *) present in the isocyanate-reactive compound (b) before the reaction. The isocyanate-reactive compound (b) can be one or a mixture of any two or more selected from the group consisting of the compounds represented by the general formulae (2a), (2b), and (2c); especially, the isocyanate-reactive compound (b) is preferably one represented by the general formula (2a).

The isocyanate group-containing compound (a) can be one or a mixture of any two or more selected from the group consisting of isocyanate, diisocyanate, and polyisocyanate. When the isocyanate group-containing compound (a) is diisocyanate and/or polyisocyanate and the isocyanate-reactive compound (b) has two or more-OH groups and/or —COOH groups in total, the reaction product obtained from them is optionally a polymer, but not limited thereto.

The isocyanate, diisocyanate, and polyisocyanate are preferably one or more selected from the group consisting of compounds represented by the following formulae (3a) to (3 h).

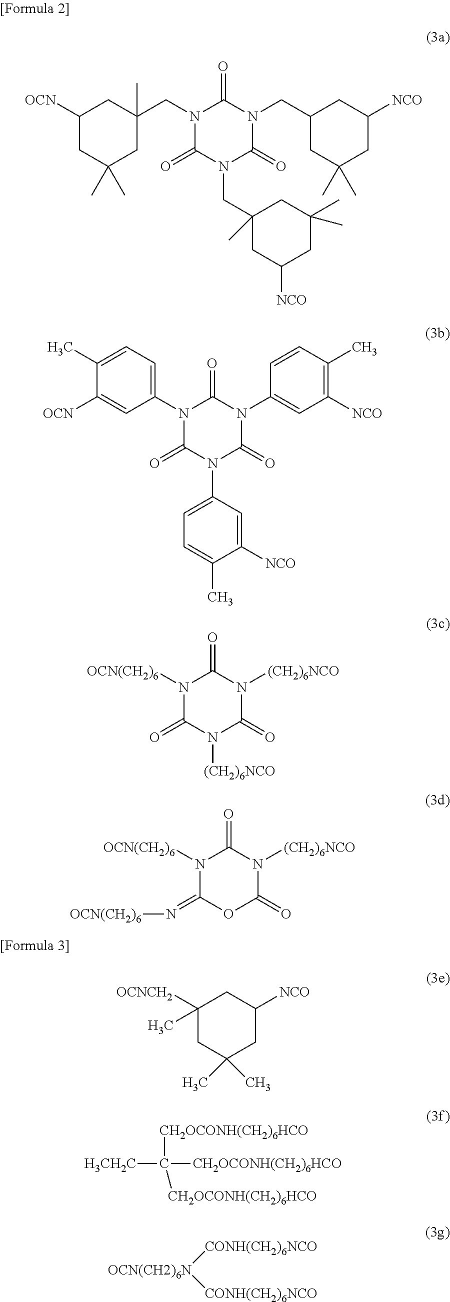

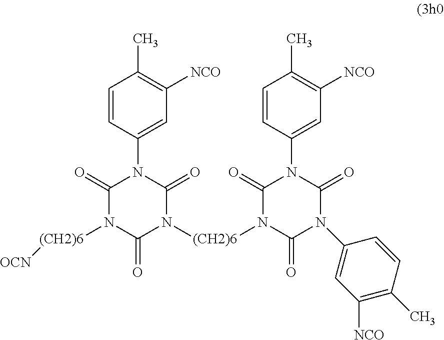

Examples of the isocyanate derivative include isocyanate derivatives described in JP 2022-33218 A (WO 2016/049278), JP 6987847 B (WO 2018/031534), and WO 2021/251302.

### Polymer

The liquid-repellent compound in the present disclosure may be a polymer. The polymer is a compound obtained by reacting a monomer, and contains repeating units derived from the monomer. Polymers obtained by reacting a monomer contain structural units derived from the monomer.

The polymer may be an acrylic polymer. The acrylic polymer is a compound obtained by reacting an acrylic monomer, and contains repeating units derived from the acrylic monomer. Acrylic polymers obtained by reacting an acrylic monomer are such polymers that contain structural units derived from the acrylic monomer and have chemical structures derived from ethylenically unsaturated groups as a main chain.

The acrylic monomer is not limited as long as it is a monomer containing an ethylenically unsaturated bond, and examples thereof include a monomer having an ethylenically unsaturated group such as a vinyl group, a vinylene group, a vinylidene group, a (meth)acryloyl group, or a (meth)acrylamide group. A hydrogen atom bonded to the carbon atoms forming the ethylenically unsaturated bond may be replaced with a monovalent organic group or a halogen atom.

The liquid-repellent compound in the present disclosure may be a polymer having repeating units derived from a monomer represented by the following formula:

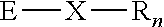

wherein E is an organic residue having an ethylenically unsaturated polymerizable group,
X is a direct bond or a 1+n valent group,
R is independently at each occurrence an aliphatic hydrocarbon group having 4 or more and 40 or less carbon atoms, having at least one alkylsilyl group, and optionally having a substituent, and
n is 1 to 3 or less.
E may be an organic residue having an ethylenically unsaturated polymerizable group, and is not limited as long as a carbon-to-carbon double bond is present. Specific examples include an organic residue having an ethylenically unsaturated polymerizable group such as CH₂═C(—R¹¹¹)—C(═O)—, CH₂═C(—R¹¹¹)—, and CH₂═C(—R¹¹¹)—CH₂—, and examples of R¹¹¹ include a hydrogen atom, a methyl group, or a halogen atom. E may have various organic groups other than ethylenically unsaturated polymerizable groups, and examples of such organic groups include a chain hydrocarbon, a cyclic hydrocarbon, a polyoxyalkylene group, and a polysiloxane group, and these organic groups may be substituted with various substituents.
E is preferably a group represented by the general formula:

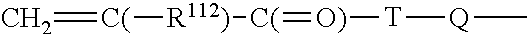

wherein R¹¹² is a hydrogen atom, a methyl group, or a halogen atom, Y is —O— or —NH—, and Q is a direct bond or a divalent organic group.
R¹¹² is a hydrogen atom, a methyl group, or a halogen atom, and accordingly the x position of the monomer (a) (acrylate or methacrylate) may have a hydrogen atom or be substituted with a halogen atom or the like.
X is a direct bond or a 1+n valent group, and the explanation of X in the Z group is applied.
Q may be a direct bond or a divalent organic group; when Q is a divalent organic group, examples thereof include an aliphatic group having 1 to 10 carbon atoms, an aromatic group or cyclic aliphatic group having 6 to 18 carbon atoms,
a —(CH₂)ₘ—N(R¹)SO₂—(CH₂)ₙ— group (m is an integer of 1 to 10, n is an integer of 0 to 10, and R¹ is an alkyl group having 1 to 18 carbon atoms),
a —CH₂CH(OZ¹)CH₂— group (Z¹ is a hydrogen atom or R¹C(═O)—, and R¹ is an alkyl group having 1 to 18 carbon atoms),
a —CH₂CH(OZ¹)CH₂—(Ph-O)— group (Z¹ is a hydrogen atom or RIC(═O)—, R¹ is an alkyl group having 1 to 18 carbon atoms, and Ph is a phenylene group),
a —(CH₂)ₙ-Ph-O— group (provided that Ph is a phenylene group, and n is an integer of 0 to 10),
a —(CH₂)ₘ—SO₂—(CH₂)ₙ— group (m is an integer of 1 to 10, and n is an integer of 0 to 10),
a —(CH₂)ₘ—OC(═O)N(R¹)—(CH₂)ₙ— group (m is an integer of 1 to 10, n is an integer of 0 to 10, and R¹ is an alkyl group having 1 to 18 carbon atoms),
a —(CH₂)ₘ—N(R¹)C(═O)O—(CH₂)ₙ— group (m is an integer of 1 to 10, n is an integer of 0 to 10, and R¹ is an alkyl group having 1 to 18 carbon atoms),
a —(CH₂)ₘ—C(═O)N(R¹)—(CH₂)ₙ— group (m is an integer of 1 to 10, n is an integer of 0 to 10, and R¹ is an alkyl group having 1 to 18 carbon atoms),
a —(CH₂)ₘ—(R¹)NC(═O)—(CH₂)ₙ— group (m is an integer of 1 to 10, n is an integer of 0 to 10, and R¹ is an alkyl group having 1 to 18 carbon atoms),
a —(CH₂)ₘ—(R¹)NC(═O)N(R¹)—(CH₂)ₙ— group (m is an integer of 1 to 10, n is an integer of 0 to 10, and R¹ is an alkyl group having 1 to 18 carbon atoms), or
a —(CH₂)ₘ—S—(CH₂)ₙ— group (m is an integer of 1 to 10, and n is an integer of 0 to 10).
R is as described above.

### Vinyl Polymer

The liquid-repellent compound in the present disclosure may be a polymer containing repeating units derived from a liquid-repellent compound having the Z group and represented by the following formula:

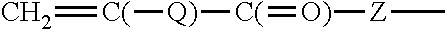

wherein Q is a hydrogen atom, a monovalent organic group, or a halogen atom except a fluorine atom.

Examples of the monovalent organic group include a cyano group, an aliphatic hydrocarbon group having 1 to 6 carbon atoms (e.g., an alkyl group, an alkenyl group), and an aromatic group having 5 to 12 carbon atoms. Examples of the halogen atom except a fluorine atom include chlorine, bromine, and iodine. Q may be a hydrogen atom, a halogen atom, a methyl group, a cyano group, a substituted or non-substituted benzyl group, or a substituted or non-substituted phenyl group, and is, for example, a hydrogen atom, a methyl group, a chlorine atom, a bromine atom, an iodine atom, or a cyano group, preferably a hydrogen atom, a methyl group, or a chlorine atom, and, in particular, a hydrogen atom or a methyl group.

The Z group is as described above.

The polymer may be a polymer containing an amide group, a urea group, or a urethane group in X from the viewpoint of the improvement in liquid-repellency.

### {Amount of Liquid-Repellent Compound}

The amount of the liquid-repellent compound may be 0.01% by weight or more, 0.03% by weight or more, 0.5% by weight or more, 1% by weight or more, 3% by weight or more, 5% by weight or more, 10% by weight or more, 20% by weight or more, 30% by weight or more, and 60% by weight or less, 50% by weight or less, 40% by weight or less, 30% by weight or less, 20% by weight or less, 10% by weight or less, 5% by weight or less, or 3% by weight or less in the surface modifier. The liquid-repellent compound itself may be used as a surface modifier.

### {Method for Producing Liquid-Repellent Compound}

The liquid-repellent compound may be produced by modifying a base material compound, which is to serve as a base material of the liquid-repellent compound, with the Z group. Specifically, the liquid-repellent compound may be produced by modifying at least one functional group that a base material compound for the liquid-repellent compound has with the Z group. The functional group may be an active hydrogen-containing group, and examples thereof include an amino group, a hydroxy group, or a carboxy group. The modification of a functional group with the Z group may be replacing a functional group with the Z group, or replacing an active hydrogen that a functional group has.

The base material compound is at least one selected from the group consisting of the compounds shown as examples in the above: the polycarboxylic acids, polyols, polyamines, aromatic compounds, nitrogen-containing cyclic compounds, isocyanate derivatives, isocyanate group-containing compounds, isocyanate-reactive compounds, and derivatives thereof.

In an embodiment, the liquid-repellent compound may be produced by replacing an active hydrogen in at least one functional group that a base material compound for the liquid-repellent compound has with the Z group. For example, the liquid-repellent compound may be produced by replacing a hydrogen atom that at least one amino group, hydroxy group, or carboxyl group of a base material compound for the liquid-repellent compound has with the Z group.

The base material for the compound may be any one of the base material compounds shown as examples in the above, and may be a compound formed by bonding one or more functional groups such as a hydroxyl group, an amino group, an isocyanate group, and a carboxyl group to any one of the base material compounds shown as examples in the above.

The method for modifying the base material compound with the Z group is not limited. For example, urethane bond formation reaction, urea bond formation reaction, ester bond formation reaction, amide bond formation reaction, and ether bond formation reaction are applicable as the method. In bond formation reaction, for example, an acylating agent, a condensing agent, or a catalyst is appropriately used.

The method for modifying the base material compound with the Z group may be performed by reacting the base material compound and a hydrocarbon group-containing reactant having an alkylsilyl group. The hydrocarbon group-containing reactant having an alkylsilyl group is a compound having an aliphatic hydrocarbon group having an alkylsilyl group and a group that can react with a functional group of the base material compound.

Examples of the hydrocarbon group-containing reactant are as follows:

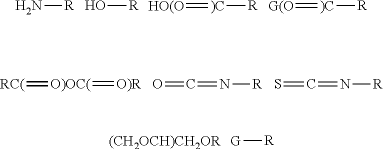

wherein R is an aliphatic hydrocarbon group having 6 or more and 40 or less carbon atoms and having at least one alkylsilyl group, and as defined above; and G is a halogen atom (in particular, F, Cl, Br, or I).

### Urethane Bond Formation

The base material compound and the hydrocarbon group having an alkylsilyl group may be bonded via a urethane bond. Such a urethane bond may be formed, for example, by reacting a hydroxyl group-containing base material compound and an aliphatic hydrocarbon-containing isocyanate having an alkylsilyl group. In the reaction, a tin catalyst or an amine can be used as a catalyst. For example, a hydroxy group-containing base material compound and an aliphatic hydrocarbon group-containing isocyanate having an alkylsilyl group are reacted in an organic solvent for a certain period of time, as a result causing the reaction of the hydroxyl group with the isocyanate group, to give a compound of modified base material type in which the base material compound and the hydrocarbon group having an alkylsilyl group are bonded together via a urethane bond.

### Urea Bond Formation

The base material compound and the hydrocarbon group having an alkylsilyl group may be bonded via a urea bond. Such a urea bond may be formed, for example, by reacting an amino group-containing base material compound and an aliphatic hydrocarbon group-containing isocyanate group having an alkylsilyl group (or reacting an isocyanate group-containing base material compound and an aliphatic hydrocarbon group-containing amine having an alkylsilyl group). In the reaction, a catalyst may be appropriately used. For example, an amino group-containing base material compound and an aliphatic hydrocarbon-containing isocyanate are reacted in an organic solvent for a certain period of time, as a result causing the reaction of the amino group with the isocyanate group, to give a compound of modified base material type in which the base material compound and the hydrocarbon group having an alkylsilyl group are bonded together via a urea bond.

### Ester Bond Formation

The base material compound and the hydrocarbon group having an alkylsilyl group may be bonded via an ester bond. Such an ester bond may be formed, for example, by reacting a hydroxyl group-containing base material compound and an aliphatic hydrocarbon group-containing carboxylic acid having an alkylsilyl group (or reacting a carboxylic acid-containing base material compound and an aliphatic hydrocarbon group-containing alcohol having an alkylsilyl group). In the reaction, for example, an acylating catalyst or a condensing agent may be used. For example, a hydroxyl group-containing base material compound and an aliphatic hydrocarbon group-containing carboxylic acid having an alkylsilyl group are reacted in an organic solvent for a certain period of time, as a result causing the reaction of the hydroxyl group with the carboxylic acid, to give a compound of modified base material type in which the base material compound and the hydrocarbon group having an alkylsilyl group are bonded together via an ester bond.

### Amide Bond Formation

The base material compound and the hydrocarbon group having an alkylsilyl group may be bonded via an amide bond. Such an amide bond may be formed, for example, by reacting an amino group-containing base material compound and an aliphatic hydrocarbon group-containing carboxylic acid having an alkylsilyl group (or reacting a carboxylic acid-containing base material compound and an aliphatic hydrocarbon group-containing amine having an alkylsilyl group). In the reaction, for example, an acylating catalyst or a condensing agent may be used. For example, an amino group-containing base material compound and an aliphatic hydrocarbon group-containing carboxylic acid having an alkylsilyl group are reacted in an organic solvent for a certain period of time, as a result causing the reaction of the amino group with the carboxylic acid, to give a compound of modified base material type in which the base material compound and the hydrocarbon group having an alkylsilyl group are bonded together via an amide bond.

### Ether Bond Formation

The base material compound and the hydrocarbon group having an alkylsilyl group may be bonded via an ether bond. Such an ether bond may be formed, for example, by reacting a halogen-containing base material compound and an aliphatic hydrocarbon group-containing alcohol having an alkylsilyl group (or reacting a hydroxyl group-containing base material compound and an aliphatic hydrocarbon group-containing halide having an alkylsilyl group). In the reaction, for example, an acid catalyst or a base catalyst may be used. For example, a halogen-containing base material compound and an aliphatic hydrocarbon group-containing alcohol having an alkylsilyl group are reacted by heating in an organic solvent in the presence of a catalyst, as a result allowing the aliphatic hydrocarbon group-containing alcohol having an alkylsilyl group to function as a nucleophile, to give a compound of modified base material type in which the base material compound and the hydrocarbon group having an alkylsilyl group are bonded together via an ether bond.

### Polymer Formation

The compound in the present disclosure may be obtained by polymerizing a monomer containing the Z group. The monomer containing the Z group may be a monomer formed by modifying a monomer such as acrylic acid and acryloyl chloride with the Z group. Such a monomer may be a monomer modified with the Z group explained in the above.

### (Polymerization Method)

A polymer containing the Z group can be produced by a known polymerization method, and conditions for polymerization reaction can be arbitrarily selected. Examples of such polymerization methods include solution polymerization, suspension polymerization, emulsion polymerization, and condensation polymerization.

In solution polymerization, a method is employed in which a monomer is dissolved in an organic solvent in the presence of a polymerization initiator, and, after nitrogen purge, the resultant is stirred with heating at a temperature in the range of 30 to 120° C. for 1 to 10 hours. Examples of the polymerization initiator include azobisisobutyronitrile, benzoyl peroxide, di-t-butyl peroxide, lauryl peroxide, cumene hydroperoxide, t-butyl peroxypivalate, and diisopropyl peroxydicarbonate. The polymerization initiator is used in an amount in the range of 0.01 to 20 parts by weight, for example, 0.01 to 10 parts by weight, relative to 100 parts by weight of the monomer.

The organic solvent is one that is inert to the monomer and dissolves the monomer therein, and may be, for example, an ester (e.g., an ester having 2 to 40 carbon atoms, specifically, ethyl acetate, butyl acetate), a ketone (e.g., a ketone having 2 to 40 carbon atoms, specifically, methyl ethyl ketone, diisobutyl ketone, methyl isobutyl ketone), or an alcohol (e.g., an alcohol having 1 to 40 carbon atoms, specifically, ethanol, butanol, isopropyl alcohol). Specific examples of the organic solvent include acetone, chloroform, HCHC225, isopropyl alcohol, cyclohexane, benzene, toluene, xylene, petroleum ether, tetrahydrofuran, 1,4-dioxane, methyl ethyl ketone, methyl isobutyl ketone, diisobutyl ketone, ethyl acetate, butyl acetate, 1,1,2,2-tetrachloroethane, 1,1,1-trichloroethane, trichloroethylene, perchloroethylene, tetrachlorodifluoroethane, and trichlorotrifluoroethane. The organic solvent is used in an amount in the range of 10 to 3,000 parts by weight, for example, 50 to 2,000 parts by weight, relative to 100 parts by weight in total of the monomer.

In emulsion polymerization, a method is employed in which a monomer is emulsified in water in the presence of a polymerization initiator and an emulsifier, and, after nitrogen purge, the resultant is stirred to cause polymerization at a temperature in the range of 50 to 80° C. for 1 to 20 hours. Examples of the polymerization initiator include water-soluble ones such as benzoyl peroxide, lauroyl peroxide, t-butyl perbenzoate, 1-hydroxycyclohexyl hydroperoxide, 3-carboxypropionyl peroxide, acetyl peroxide, azobisisobutylamidine-dihydrochloride, sodium peroxide, potassium persulfate, and ammonium persulfate, and oil-soluble ones such as azobisisobutyronitrile, benzoyl peroxide, di-t-butyl peroxide, lauryl peroxide, cumene hydroperoxide, t-butyl peroxypivalate, and diisopropyl peroxydicarbonate. The polymerization initiator is used in an amount in the range of 0.01 to 10 parts by weight relative to 100 parts by weight of the monomer.

To obtain a polymer-water dispersion liquid excellent in standing stability, it is desired to polymerize by pulverizing a monomer in water with an emulsifying apparatus that can impart intense crushing energy such as a high pressure homogenizer and an ultrasonic homogenizer. For the emulsifier, various emulsifiers including anionic, cationic, and nonionic ones are applicable, and the emulsifier is used in an amount in the range of 0.5 to 20 parts by weight relative to 100 parts by weight of the monomer. Use of an anionic and/or nonionic and/or cationic emulsifier(s) is preferred. When the monomer is incompletely compatible, a compatibilizer that sufficiently compatibilizes the monomer, such as a water-soluble organic solvent and a low molecular weight monomer, is preferably added. The emulsifiability and copolymerizability can be improved by adding such a compatibilizer.

Any of the organic solvents described above may be used as the water-soluble organic solvent. Examples thereof include acetone, methyl ethyl ketone, ethyl acetate, propylene glycol, dipropylene glycol monomethyl ether, dipropylene glycol, tripropylene glycol, and ethanol, and the organic solvent may be used in an amount in the range of 1 to 50 parts by weight, for example, 10 to 40 parts by weight, relative to 100 parts by weight of water. Examples of the low molecular weight monomer include methyl methacrylate, glycidyl methacrylate, and 2,2,2-trifluoroethyl methacrylate, and the low molecular weight monomer may be used in an amount in the range of 1 to 50 parts by weight, for example, 10 to 40 parts by weight, relative to 100 parts by weight in total of the monomer.

In the polymerization, a chain transfer agent may be used. The molecular weight of the polymer can be varied with the amount of use of the chain transfer agent. Examples of the chain transfer agent include mercaptan group-containing compounds (in particular, alkyl mercaptan (e.g., having 1 to 40 carbon atoms)) such as lauryl mercaptan, thioglycol, and thioglycerol, and inorganic salts such as sodium hypophosphite and sodium hydrogen sulfite. The amount of use of the chain transfer agent may be in the range of 0.01 to 10 parts by weight, for example, 0.1 to 5 parts by weight, relative to 100 parts by weight in total of the monomer.

### {Dispersant]}

The surface modifier of the present disclosure may contain a dispersant.

The dispersant may be at least one selected from an organic dispersant and an inorganic dispersant. The dispersant may be a non-anionic, and may be at least one selected from a nonionic dispersant, a cationic dispersant, an amphoteric dispersant, and an inorganic dispersant. The surface modifier may be free of an anionic dispersant.

An organic dispersant and an inorganic dispersant may be used as the dispersant, respectively, or an organic dispersant and an inorganic dispersant may be used in combination.

An organic dispersant may be used as the dispersant. The organic dispersant may be classified into a nonionic dispersant, an anionic dispersant, a cationic dispersant and an amphoteric dispersant. The organic dispersant may mean a surfactant.

The dispersant may be a compound having no fluorine.

### [Nonionic Dispersant]

The dispersant may comprise a nonionic dispersant.

The nonionic dispersant may be a nonionic surfactant.

The nonionic dispersant may be of low molecular weight or high molecular weight. The nonionic dispersant may have a molecular weight of 100 or more, 500 or more, 1,000 or more, 2,000 or more, 4,000 or more, or 6,000 or more. The molecular weight may be 100,000 or less, 10,000 or less, 7,500 or less, 5,000 or less, 2,500 or less, 750 or less, or 250 or less.

Examples of nonionic dispersant include ether, ester, ester ether, alkanolamide, polyol and amine oxide.

The ether is, for example, a compound having an oxyalkylene group (preferably a polyoxyethylene group).

The ester is, for example, an ester of an alcohol and a fatty acid. The alcohol is, for example, an alcohol which is 1 to 6 hydric (particularly dihydric to pentahydric) and has 1 to 50 carbon atoms (particularly 10 to 30 carbon atoms) (for example, an aliphatic alcohol). Examples of the fatty acids are saturated or unsaturated fatty acids having 2 to 50 carbon atoms, particularly 5 to 30 carbon atoms.

The ester ether is, for example, a compound in which an alkylene oxide (particularly ethylene oxide) is added to an ester of an alcohol and a fatty acid. The alcohol is, for example, an alcohol which is 1 to 6 hydric (particularly dihydric to pentahydric) and has 1 to 50 carbon atoms (particularly 3 to 30 carbon atoms) (for example, an aliphatic alcohol). Examples of the fatty acids are saturated or unsaturated fatty acids having 2 to 50 carbon atoms, particularly 5 to 30 carbon atoms.

The alkanolamide is formed of for example, a fatty acid and an alkanolamine. The alkanolamide may be a monoalkanolamide or a dialkanolamide. Examples of the fatty acids are saturated or unsaturated fatty acids having 2 to 50 carbon atoms, particularly 5 to 30 carbon atoms. The alkanolamine may be an alkanol with 1 to 3 amino groups and 1 to 5 hydroxyl groups, having 2 to 50, particularly 5 to 30 carbon atoms.

The polyol may be, for example, a dihydric to pentahydric alcohol having 10 to 30 carbon atoms.

The amine oxide may be an oxide (for example, having 5 to 50 carbon atoms) of an amine (secondary amine or preferably tertiary amine).

The nonionic dispersant is preferably a nonionic dispersant having an oxyalkylene group (preferably a polyoxyethylene group). The alkylene group in the oxyalkylene group preferably has 2 to 10 carbon atoms. The number of oxyalkylene groups in the molecule of the nonionic dispersant is generally preferably 2 to 100.

The nonionic dispersant is selected from the group consisting of an ether, an ester, an ester ether, an alkanolamide, a polyol, or an amine oxide, and is preferably a nonionic dispersant having an oxyalkylene group.

The nonionic dispersant may be, for example, an alkylene oxide adduct of a linear and/or branched aliphatic (saturated and/or unsaturated) group, a polyalkylene glycol ester of a linear and/or branched fatty acid (saturated and/or unsaturated), a sorbitan ester of a linear and/or branched fatty acid (saturated and/or unsaturated), a glycerin ester of a linear and/or branched fatty acid (saturated and/or unsaturated), a polyglycerol ester of a linear and/or branched fatty acid (saturated and/or unsaturated), a sucrose ester of a linear and/or branched fatty acid (saturated and/or unsaturated), a polyoxyethylene (POE)/polyoxypropylene (POP) copolymer (random copolymer or block copolymer), and an alkylene oxide adduct of acetylene glycol. Among them, the nonionic dispersant is preferably a dispersant such that the structures of the alkylene oxide addition moiety and polyalkylene glycol moiety are polyoxyethylene (POE) or polyoxypropylene (POP) or POE/POP copolymer (which may be a random or block copolymer, for example.).

Furthermore, the nonionic dispersant may not include an aromatic group.

The nonionic dispersant may be the compound represented by the formula:

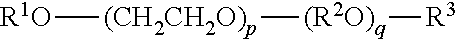

[wherein R¹ is an alkyl group having 1 to 22 carbon atoms, an alkenyl group or an acyl group, having 2 to 22 carbon atoms,
R² is each independently the same or different and is an alkylene group having 3 or more carbon atoms (for example, 3 to 10),
R³ is a hydrogen atom, an alkyl group having 1 to 22 carbon atoms, or an alkenyl group having 2 to 22 carbon atoms,
p is a numeral of 2 or more,
q is 0 or a numeral of 1 or more.].
   R¹ preferably has 8 to 20 carbon atoms, particularly 10 to 18 carbon atoms. Preferred examples of R¹ include a lauryl group, a tridecyl group, and an oleyl group.
   R² is, for example, a propylene group and a butylene group.

In the nonionic dispersant, for example, p may be a numeral of 3 or more (for example, 5 to 200) and q may be a numeral of 2 or more (for example, 5 to 200). Namely, —(R²O)_{q}— may form, for example, a polyoxyalkylene chain.

The nonionic dispersant may be, for example, a polyoxyethylene alkylene alkyl ether comprising a hydrophilic polyoxyethylene chain and a hydrophobic oxyalkylene chain (particularly a polyoxyalkylene chain) in the center. The hydrophobic oxyalkylene chain includes, for example, an oxypropylene chain, an oxybutylene chain, and a styrene chain. The oxypropylene chain is preferred among them.

Specific examples of the nonionic dispersants include a condensation product of ethylene oxide with hexylphenol, isooctatylphenol, hexadecanol, oleic acid, an alkane(C₁₂-C₁₆)thiol, a sorbitan monofatty acid (C₇-C₁₉), an alkyl(C₁₂-C₁₈)amine, or the like, and a sorbitan fatty acid ester, a glycerin fatty acid ester, a polyglycerin fatty acid ester, a sucrose fatty acid ester, a propylene glycol fatty acid ester, a polyoxyethylene alkyl ether, a polyoxyethylene polyoxypropylene alkyl ether, a polyoxyethylene glycerin fatty acid ester, a polyoxyethylene sorbitan fatty acid ester, and a lecithin derivative.

The proportion of the polyoxyethylene block can be 5 to 80% by weight, for example, 30 to 75% by weight, particularly 40 to 70% by weight, based on a molecular weight of the nonionic dispersant (copolymer).

The average molecular weight of the nonionic dispersant is generally 300 to 5,000, for example, 500 to 3,000.

For example, the nonionic dispersant may be used singly or in admixture of two or more. The nonionic dispersant may be a mixture of a compound with an HLB (hydrophilic-hydrophobic balance) of less than 15 (particularly 5 or less) and a compound with an HLB of 15 or more.

### [Cationic Dispersant]

The dispersant may comprise a cationic dispersant. The cationic dispersant may be a cationic surfactant. The cationic dispersant may be of low molecular weight (with a molecular weight of 2,000 or less, in particular, 1,000 or less) or of high molecular weight (with a molecular weight of, for example, 2,000 or more). The cationic dispersant may be a compound having no amide group.

The cationic dispersant may be of low molecular weight or of high molecular weight. The cationic dispersant may have a molecular weight of 100 or more, 500 or more, 1,000 or more, 2,000 or more, 4,000 or more, or 6,000 or more. The molecular weight may be 100,000 or less, 10,000 or less, 7,500 or less, 5,000 or less, 2,500 or less, 750 or less, or 250 or less.

The cationic dispersant may be an amine salt, a quaternary ammonium salt, or an oxyethylene-added ammonium salt. Specific examples of the cationic dispersant include, but are not limited to, an amine salt dispersant such as alkylamine salt, an amino alcohol fatty acid derivative, a polyamine fatty acid derivative, and imidazoline, and a quaternary ammonium salt dispersant such as alkyl trimethyl ammonium salt, dialkyl dimethyl ammonium salt, alkyl dimethyl benzyl ammonium salt, pyridinium salt, alkyl isoquinolinium salt, and benzethonium chloride.

Preferred examples of the cationic dispersant include a compound represented by the formula:

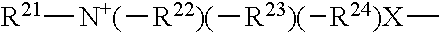

wherein R²¹, R²², R²³ and R²⁴ are a hydrocarbon group having 1 to 40 carbon atoms, and
X is an anionic group.

Specific examples of R²¹, R²², R²³ and —R²⁴ include an alkyl group (e.g., a methyl group, a butyl group, a stearyl group, a palmityl group). Specific examples of X include a halogen (e.g., chlorine) and an acid (e.g., hydrochloric acid and acetic acid).

The cationic dispersant is particularly preferably monoalkyltrimethylammonium salt (in which alkyl has 4 to 40 carbon atoms).

The cationic dispersant is preferably an ammonium salt. The cationic dispersant may be an ammonium salt represented by the formula:

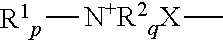

[wherein R¹ is a C12 or higher (e.g., C₁₂ to C₅₀) linear and/or branched aliphatic (saturated and/or unsaturated) group,
R² is H or a C1 to 4 alkyl group, a benzyl group, a polyoxyethylene group (in which the number of oxyethylene groups is for example, 1 (in particular 2, and especially 3) to 50) (particularly preferably CH₃, C₂H₅),
X is a halogen atom (e.g., chlorine atom) or a C₁ to C₄ fatty acid base,
p is 1 or 2, q is 2 or 3 and p+q=4.]
R¹ may have 12 to 50, and for example 12 to 30 carbon atoms.

Specific examples of the cationic dispersants include dodecyltrimethylammonium acetate, trimethyltetradecylammonium chloride, hexadecyltrimethylammonium bromide, trimethyloctadecylammonium chloride, (dodecylmethylbenzyl)trimethylammonium chloride, benzyldodecyldimethylammonium chloride, methyldodecyl di(hydropolyoxyethylene) ammonium chloride, benzyldodecyl di(hydropolyoxyethylene) ammonium chloride, and N-[2-(diethylamino)ethyl]oleamide hydrochloride.

### [Anionic Dispersant]

The dispersant may comprise an anionic dispersant. The anionic dispersant may be an anionic surfactant. The dispersant may not include an anionic dispersant.

The anionic dispersant may be of low molecular weight or high molecular weight. The anionic dispersant may have a molecular weight of 100 or more, 500 or more, 1,000 or more, 2,000 or more, 4,000 or more, or 6,000 or more. The molecular weight may be 100,000 or less, 10,000 or less, 7,500 or less, 5,000 or less, 2,500 or less, 750 or less, or 250 or less.

Examples of the anionic dispersant include an alkyl ether sulfate, an alkyl sulfate, an alkenyl ether sulfate, an alkenyl sulfate, an olefin sulfonate, an alkanesulfonate, a saturated or unsaturated fatty acid salt, an alkyl or alkenyl ether carbonate, an x-sulfone fatty acid salt, a N-acylamino acid dispersant, a phosphate mono- or diester dispersant, and a sulfosuccinic acid ester.

### [Amphoteric Dispersant]

The dispersant may comprise an amphoteric dispersant. The amphoteric dispersant may be an amphoteric surfactant.

The amphoteric dispersant may be of low molecular weight or high molecular weight. The amphoteric dispersant may have a molecular weight of 100 or more, 500 or more, 1,000 or more, 2,000 or more, 4,000 or more, or 6,000 or more. The molecular weight may be 100,000 or less, 10,000 or less, 7,500 or less, 5,000 or less, 2,500 or less, 750 or less, or 250 or less.

Examples of the amphoteric dispersants include, for example, alanines, imidazolinium betaines, amidobetaines, and acetic acid betaine, and specific examples of the amphoteric dispersants include, for example, lauryl betaine, stearyl betaine, lauryl carboxymethyl hydroxyethyl imidazolinium betaine, lauryl dimethylamino acetic acid betaine, and fatty acid amidopropyldimethylaminoacetic acid betaine.

### [Inorganic Dispersant]

The dispersant may comprise an inorganic dispersant.

The inorganic dispersant has an average primary particle size of 5 nm or larger, 30 nm or larger, 100 nm or larger, 1 μm or larger, 10 μm or larger, or 25 μm or larger. The average primary particle size of the inorganic dispersant may be 100 μm or less, 50 μm or less, 10 μm or less, 1 μm or less, 500 nm or less, or 300 nm or less. The average primary particle size may be measured by a microscope, for example, a scanning electron microscope or a transmission electron microscope. The inorganic dispersant may be hydrophilic particles.

Examples of inorganic dispersants include polyvalent metal phosphate such as tricalcium phosphate, magnesium phosphate, aluminum phosphate, zinc phosphate and hydroxyapatite; carbonate such as calcium carbonate and magnesium carbonate; silicate such as calcium metasilicate; sulfate such as calcium sulfate and barium sulfate; and hydroxide such as calcium hydroxide, magnesium hydroxide and aluminum hydroxide.

### [Amount of Dispersant]

The amount of dispersant may be 0.01 parts by weight or more, 0.1 parts by weight or more, 1 part by weight or more, 3 parts by weight or more, 5 parts by weight or more, 10 parts by weight, 15 parts by weight or more, 20 parts by weight or more, 50 parts by weight or more, 75 parts by weight or more, or 100 parts by weight or more, relative to 100 parts by weight of the liquid-repellent compound. The amount of the dispersant may be 500 parts by weight or less, 300 parts by weight or less, 200 parts by weight or less, 100 parts by weight or less, 30 parts by weight or less, 20 parts by weight or less, 10 parts by weight or less, 5 parts by weight or less, 3 parts by weight or less, or 1 part by weight or less, relative to 100 parts by weight of the liquid-repellent compound.

### {Liquid Medium}

The surface modifier in the present disclosure may comprise a liquid medium. The liquid medium may be water, an organic solvent, or a mixture of water and an organic solvent. The surface modifier may be a dispersion or a solution. The surface modifier in the present disclosure is in the form of a water dispersion, and includes at least water.

Examples of the organic solvents include esters (for example, esters having 2 to 40 carbon atoms, specifically ethyl acetate and butyl acetate), ketones (for example, ketones having 2 to 40 carbon atoms, specifically methyl ethyl ketone and diisobutyl ketone), alcohols (for example, alcohols having 1 to 40 carbon atoms, specifically isopropyl alcohol), aromatic solvents (for example, toluene and xylene), petroleum-based solvents (for example, alkanes having 5 to 10 carbon atoms, specifically, naphtha and kerosene). The organic solvent is preferably a water-soluble organic solvent. The water-soluble organic solvent may include a compound having at least one hydroxy group (for example, polyol such as alcohol and glycol solvent, and an ether form of polyol (for example, a monoether form)). These may be used alone, or two or more of them may be used in combination.

### [Amount of Liquid Medium]

The amount of liquid medium may be 1 part by weight or more, 3 parts by weight or more, 5 parts by weight or more, 10 parts by weight or more, 20 parts by weight or more, 30 parts by weight or more, 40 parts by weight or more, or 50 parts by weight or more, 100 parts by weight or more, 200 parts by weight or more, 300 parts by weight or more, 500 parts by weight or more, or 1,000 parts by weight or more, relative to 1 part by weight of the liquid-repellent compound. The amount of the liquid medium may be 3,000 parts by weight or less, 2,000 parts by weight or less, 1,000 parts by weight or less, 500 parts by weight or less, 200 parts by weight or less, 175 parts by weight or less, 150 parts by weight or less, 125 parts by weight or less, 100 parts by weight or less, 80 parts by weight or less, 60 parts by weight or less, 40 parts by weight or less, 20 parts by weight or less, or 10 parts by weight or less, relative to 1 part by weight of the liquid-repellent compound.

The amount of water may be 1 part by weight or more, 3 parts by weight or more, 5 parts by weight or more, 10 parts by weight or more, 20 parts by weight or more, 30 parts by weight or more, 40 parts by weight or more, 50 parts by weight or more, 100 parts by weight or more, 200 parts by weight or more, 300 parts by weight or more, 500 parts by weight or more, or 1,000 parts by weight or more, based on 1 part by weight of the liquid-repellent compound. The amount of water may be 3,000 parts by weight or less, 2,000 parts by weight or less, 1,000 parts by weight or less, 500 parts by weight or less, 200 parts by weight or less, 175 parts by weight or less, 150 parts by weight or less, 125 parts by weight or less, 100 parts by weight or less, 80 parts by weight or less, 60 parts by weight or less, 40 parts by weight or less, 20 parts by weight or less, or 10 parts by weight or less, relative to 1 part by weight of the liquid-repellent compound.

The amount of the organic solvent may be 1 part by weight or more, 3 parts by weight or more, 5 parts by weight or more, 10 parts by weight or more, 20 parts by weight or more, 30 parts by weight or more, 40 parts by weight or more, 50 parts by weight or more, 100 parts by weight or more, 200 parts by weight or more, 300 parts by weight or more, 500 parts by weight or more, or 1,000 parts by weight or more, relative to 1 part by weight of the liquid-repellent compound. The amount of the organic solvent may be 3,000 parts by weight or less, 2,000 parts by weight or less, 1,000 parts by weight or less, 500 parts by weight or less, 200 parts by weight or less, 175 parts by weight or less, 150 parts by weight or less, 125 parts by weight or less, 100 parts by weight or less, 80 parts by weight or less, 60 parts by weight or less, 40 parts by weight or less, 20 parts by weight or less, or 10 parts by weight or less, relative to 1 part by weight of the liquid-repellent compound.

### {Silicone}

The surface modifier in the present disclosure may include silicone (polyorganosiloxane). Containing the silicone enables providing favorable texture and durability in addition to favorable liquid-repellency.

As the silicone, a known silicone can be used, and examples of the silicone include a polydimethylsiloxane and modified silicones (for example, amino-modified silicone, epoxy-modified silicone, carboxy-modified silicone, and methylhydrogen silicone). For example, the silicone may be silicone wax having waxy properties. These may be used singly or in combination of two or more thereof.

A weight average molecular weight of the silicone may be 1,000 or more, 10,000 or more, or 50,000 or more. The weight average molecular weight of the silicone may be 500,000 or less, 2,500,000 or less, 100,000 or less, or 50,000 or less.

### [Amount of Silicone]

The amount of silicone may be 0.1 parts by weight or more, 1 part by weight or more, 3 parts by weight or more, 5 parts by weight or more, 10 parts by weight or more, 15 parts by weight or more, 20 parts by weight or more, 50 parts by weight or more, 75 parts by weight or more, or 100 parts by weight or more, relative to 100 parts by weight of the liquid-repellent compound. The amount of the silicone may be 500 parts by weight or less, 300 parts by weight or less, 200 parts by weight or less, 100 parts by weight or less, 50 parts by weight or less, 40 parts by weight or less, 30 parts by weight or less, 20 parts by weight or less, 10 parts by weight or less, or 5 parts by weight or less, relative to 100 parts by weight of the liquid-repellent compound.

### {Wax}

The surface modifier in the present disclosure may include wax. Containing the wax can impart favorable liquid-repellency to a substrate.

Examples of wax include paraffin wax, microcrystalline wax, Fischer-Tropsch wax, polyolefin wax (for example, polyethylene wax and polypropylene wax), oxidized polyolefin wax, silicone wax, animal and vegetable wax and mineral wax. Paraffin wax is preferred. Specific examples of compounds constituting wax include n-alkane (such as tricosan, tetracosane, pentacosane, hexacosane, heptacosan, octacosan, nonacosane, triacontane, hentriacontane, dotriacontane, tritriacontane, tetratriacontane, pentatriacontane, hexatriacontane), n-alkene (such as 1-icosene, 1-docosene, 1-tricosene, 1-tetracosene, 1-pentacosene, 1-hexacosene, 1-heptacosene, 1-octacosene, nonacosane, triacontane, hentriacontane, dotriacontane, tritriacontane, tetratriacontane, pentatriacontane, hexatriacontane). The number of carbon atom in the compound constituting the wax is preferably 20 to 60, for example 25 to 45. A molecular weight of the wax may be 200 to 2,000, for example, 250 to 1,500 or 300 to 1,000. These may be used singly or in combination of two or more thereof.

The wax may have a melting point of 40° C. or higher, 50° C. or higher, 55° C. or higher, 60° C. or higher, 65° C. or higher, or 70° C. or higher, preferably 55° C. or higher, more preferably 60° C. or higher. The melting point of wax is measured according to JIS K 2235-1991.

### [Amount of Wax]

The amount of wax may be 0.1 parts by weight or more, 1 part by weight or more, 3 parts by weight or more, 5 parts by weight or more, 10 parts by weight or more, 15 parts by weight or more, 20 parts by weight or more, 50 parts by weight or more, 75 parts by weight or more, or 100 parts by weight or more, relative to 100 parts by weight of the liquid-repellent compound. The amount of the wax may be 500 parts by weight or less, 300 parts by weight or less, 200 parts by weight or less, 100 parts by weight or less, 50 parts by weight or less, 40 parts by weight or less, 30 parts by weight or less, 20 parts by weight or less, 10 parts by weight or less, or 5 parts by weight or less, relative to 100 parts by weight of the liquid-repellent compound.

### {Organic Acid}

The surface modifier of the present disclosure may contain an organic acid. As the organic acid, a known organic acid can be used. Examples of the organic acid preferably include, for example, a carboxylic acid, a sulfonic acid, and a sulfinic acid, with the carboxylic acid being particularly preferred. Examples of the carboxylic acid include, for example, formic acid, acetic acid, propionic acid, butyric acid, oxalic acid, succinic acid, glutaric acid, adipic acid, malic acid, and citric acid, with the formic acid or acetic acid being particularly preferred. In the present disclosure, one type of organic acid may be used, or two or more thereof may be combined for use. For example, formic acid and acetic acid may be combined for use.

### [Amount of Organic Acid]

The amount of organic acid may be 0.1 parts by weight or more, 1 part by weight or more, 3 parts by weight or more, 5 parts by weight or more, 10 parts by weight or more, 15 parts by weight or more, 20 parts by weight or more, 50 parts by weight or more, 75 parts by weight or more, or 100 parts by weight or more, relative to 100 parts by weight of the liquid-repellent compound. The amount of the organic acid may be 500 parts by weight or less, 300 parts by weight or less, 200 parts by weight or less, 100 parts by weight or less, 50 parts by weight or less, 40 parts by weight or less, 30 parts by weight or less, 20 parts by weight or less, 10 parts by weight or less, or 5 parts by weight or less, relative to 100 parts by weight of the liquid-repellent compound. The amount of organic acid may be adjusted so that a pH of the surface modifier is 3 to 10, for example 5 to 9, particularly 6 to 8. For example, the surface modifier may be acidic (pH of 7 or less, for example 6 or less).

### {Curing Agent}

The surface modifier of the present disclosure may contain a curing agent (active hydrogen-reactive compound or active hydrogen-containing compound).

The curing agent (cross-linking agent) in the surface modifier can effectively cure the liquid-repellent compound. The curing agent may be an active hydrogen-reactive compound or an active hydrogen-containing compound, which reacts with an active hydrogen or an active hydrogen-reactive group that the liquid-repellent compound has. Examples of the active hydrogen-reactive compound include an isocyanate compound, epoxy compound, chloromethyl group-containing compound, carboxyl group-containing compound, and hydrazide compound. Examples of the active hydrogen-containing compound include a hydroxyl group-containing compound, an amino group-containing compound and a carboxyl group-containing compound, a ketone group-containing compound, a hydrazide compound, and a melamine compound.

The curing agent may contain an isocyanate compound. The isocyanate compound may be a polyisocyanate compound. The polyisocyanate compound is a compound having two or more isocyanate groups in one molecule. The polyisocyanate compound serves as a cross-linking agent. Examples of the polyisocyanate compound include, for example, an aliphatic polyisocyanate, an alicyclic polyisocyanate, an araliphatic polyisocyanate, an aromatic polyisocyanate, and derivatives of these polyisocyanates. The isocyanate compound may be a blocked isocyanate compound (for example, a blocked polyisocyanate compound). The blocked isocyanate compound is a compound in which an isocyanate group of an isocyanate compound is masked with a blocking agent to inhibit reaction.

Examples of the aliphatic polyisocyanates are aliphatic triisocyanates such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, an aliphatic diisocyanate of 2,6-diisocyanatomethylcaproate, and aliphatic triisocyanates such as lysine ester triisocyanate, 1,4,8-triisocyanateoctane, 1,6,11-triisocyanatoundecane, 1,8-diisocyanato-4-isocyanatomethyloctane, 1,3,6-triisocyanatohexane, 2,5,7-trimethyl-1,8-diisocyanato-5-isocyanatomethyloctane. These may be used singly or in combination of two or more thereof.

Examples of the alicyclic polyisocyanates include, for example, an alicyclic diisocyanate and an alicyclic triisocyanate. Specific examples of the alicyclic polyisocyanate include 1,3-cyclopentene diisocyanate, 3-isocyanatomethyl-3,5,5-trimethylcyclohexyl isocyanate (isophorone diisocyanate), and 1,3,5-triisocyanatocyclohexane. These may be used singly or in combination of two or more thereof.

Examples of the aromatic-aliphatic polyisocyanate include an aromatic-aliphatic diisocyanate and aromatic-aliphatic triisocyanate. Specific examples of the araliphatic polyisocyanate include 1,3- or 1,4-xylylene diisocyanate or a mixture thereof, 1,3- or 1,4-bis(1-isocyanato-1-methylethyl)benzene (tetramethyl xylylene diisocyanate) or a mixture thereof, and 1,3,5-triisocyanatomethylbenzene. These may be used singly or in combination of two or more thereof.

Examples of the aromatic polyisocyanates include an aromatic diisocyanate, aromatic triisocyanate, and aromatic tetraisocyanate. Specific examples of the aromatic polyisocyanate include, for example, m-phenylene diisocyanate, p-phenylene diisocyanate, 4,4′-diphenyl diisocyanate, 1,5-naphthalene diisocyanate, 2,4′- or 4,4′-diphenylmethane diisocyanate, or a mixture thereof, 2,4- or 2,6-tolylene diisocyanate or a mixture thereof, triphenylmethane-4,4′,4″-triisocyanate, and 4,4′-diphenylmethane-2,2′,5,5′-tetraisocyanate. These may be used singly or in combination of two or more thereof.

Examples of the derivative of the polyisocyanate include various derivatives such as a dimer, trimer, biuret, allophanate, carbodiimide, urethodione, urethoimine, isocyanurate, and iminooxadiazinedione of the aforementioned polyisocyanate compounds. These may be used singly or in combination of two or more thereof.

These polyisocyanates can be used singly or in combination of two or more thereof.

As the polyisocyanate compound, a blocked polyisocyanate compound (blocked isocyanate), which is a compound obtained by blocking isocyanate groups of the polyisocyanate compound with a blocking agent, is preferably used. The blocked polyisocyanate compound is preferably used because it is relatively stable even in solution and can be used in the same solution as solution of the surface modifier.

The blocking agent is an agent that blocks free isocyanate groups. The blocked polyisocyanate compound, for example, can be heated 100° C. or higher, for example, 130° C. or higher to regenerate isocyanate groups, facilitating a reaction with hydroxyl groups. Examples of the blocking agent include, for example, a phenolic compound, lactam-based compound, aliphatic alcohol-based compound, and oxime-based compound. The polyisocyanate compound may be used singly or in combination of two or more thereof.

The epoxy compound is a compound having an epoxy group. Examples of the epoxy compound include epoxy compounds having a polyoxyalkylene group, such as a polyglycerol polyglycidyl ether and a polypropylene glycol diglycidyl ether; as well as a sorbitol polyglycidyl ether.

The chloromethyl group-containing compound is a compound having a chloromethyl group. Examples of the chloromethyl group-containing compound include, for example, a chloromethyl polystyrene.

The carboxyl group-containing compound is a compound having a carboxyl group. Examples of the carboxyl group-containing compound include, for example, a (poly) acrylic acid, and a (poly) methacrylic acid.

Specific examples of the ketone group-containing compound include, for example, a (poly)diacetone acrylamide, and diacetone alcohol.

Specific examples of the hydrazide compound include, for example, hydrazine, a carbohydrazide, and adipic acid hydrazide.

Specific examples of the melamine compound include, for example, a melamine resin and a methyl etherified melamine resin.

### [Amount of Curing Agent]

The amount of the curing agent may be 0.1 parts by weight or more, 1 part by weight or more, 3 parts by weight or more, 5 parts by weight or more, 10 parts by weight or more, 15 parts by weight or more, or 20 parts by weight or more, 50 parts by weight or more, 75 parts by weight or more, or 100 parts by weight or more, relative to 100 parts by weight of the liquid-repellent compound. The amount of the curing agent may be 500 parts by weight or less, 300 parts by weight or less, 200 parts by weight or less, 100 parts by weight or less, 50 parts by weight or less, 40 parts by weight or less, 30 parts by weight or less, 20 parts by weight or less, 10 parts by weight or less, or 5 parts by weight or less, relative to 100 parts by weight of the liquid-repellent compound.

### {Other Component}

The surface modifier may contain a component other than the aforementioned components. Examples of the other components include, for example, polysaccharides, a paper strengthening agent, an agglomerating agent, a yield improver, a coagulant, a binder resin, an anti-slip agent, a sizing agent, a paper strengthening agent, PVA, a penetrating agent, an organic acid, a pigment, a filler, an antistatic agent, an antiseptic agent, an ultraviolet absorber, an antibacterial agent, a deodorant, and a fragrance. These may be used singly or in combination of two or more thereof.

In addition to the above components, as other components, for example, other water-repellent and/or oil-repellent agents, a dispersant, a texture modifier, a softening agent, a flame retarder, a coating material fixing agent, a wrinkle-resistant agent, a drying rate adjuster, a cross-linking agent, a film formation agent, a compatibilizer, an antifreezing agent, a viscosity adjuster, an ultraviolet absorber, an antioxidant, a pH adjuster, an insect repellent, an antifoaming agent, an anti-shrinkage agent, a laundry wrinkle-resistant agent, a shape retention agent, a drape retention agent, an ironing improving agent, a brightening agent, a whitening agent, fabric softening clay, a migration-proofing agent such as a polyvinylpyrrolidone, a polymer dispersant, a soil release agent, a scum dispersant, a fluorescent brightening agent such as 4,4-bis(2-sulfostyryl)biphenyldisodium (Tinopal CBS-X manufactured by Ciba Specialty Chemicals Plc), a dye fixing agent, an anti-color fading agent such as 1,4-bis(3-aminopropyl) piperazine, a stain removing agent, enzymes such as cellulase, amylase, protease, lipase, and keratinase as fiber surface modifiers, a foam inhibitor, and silk protein powder that can impart texture and functions of silk such as moisture absorption and release properties, and surface modified products or emulsified dispersions thereof (for example, K-50, K-30, K-10, A-705, S-702, L-710, FP series (Idemitsu Petrochemical Co., Ltd.), hydrolyzed silk liquid (Jomo), SILKGEN G Soluble S (ICHIMARU PHARCOS Co., Ltd.)), an antifouling agent (for example, a nonionic polymer compound composed of an alkylene terephthalate and/or an alkylene isophthalate units and a polyoxyalkylene unit (for example, FR627 manufactured by GOO CHEMICAL CO., LTD.), SRC-1 manufactured by Clariant (Japan), K. K.), can be compounded. These may be used singly or in combination of two or more thereof.

### [Polysaccharide]

Examples of polysaccharides include starch, xanthan gum, karaya gum, welan gum, guar gum, pectin, tamarind gum, carrageenan, chitosan, gum arabic, locust bean gum, cellulose, alginic acid, agar, dextran, cellulose, carboxymethylcellulose, hydroxyethylcellulose, hydroxypropylcellulose, chitin nanofiber, cellulose nanofiber and pullulan. Polysaccharide may be a substituted modified polysaccharide, and in particular, may be a modified polysaccharide into which a hydroxyl group or a cationic group is introduced.

### [Paper Strengthening Improver, Agglomerating Agent, Yield Improver or Coagulant]

Examples of the paper strengthening improver, agglomerating agent, yield improver or coagulant include, for example, a styrenic polymer (styrene/maleic acid polymer, styrene/acrylic acid polymer), a urea-formaldehyde polymer, a polyethyleneimine, a melamine-formaldehyde polymer, a polyamidoamine-epichlorohydrin polymer, a polyacrylamide-based polymer, a polyamine-based polymer, a polydiallyldimethylammonium chloride, a alkylamine·epichlorohydrin condensate, a condensate of alkylene dichloride and polyalkylenepolyamine, a dicyandiamide formalin condensate, a dimethyldiallylammonium chloride polymer, and an olefin/maleic anhydride polymer.

### [Sizing Agent]

Examples of the sizing agent include a cellulose-reactive sizing agent, for example, a rosin-based sizing agent such as rosin-based soap, rosin-based emulsion/a dispersion, a cellulose-reactive sizing agent, for example, emulsion/dispersions of acid anhydrides such as alkyl and alkenyl succinic anhydrides (ASA), an alkenyl and alkyl ketene dimers (AKD) and multimers thereof, and anionic, cationic and amphoteric polymers of ethylenically unsaturated monomers, for example, a styrene and acrylate copolymer.

### [Antistatic Agent]

Examples of the antistatic agent include, for example, cationic antistatic agents having cationic functional groups such as a quaternary ammonium salt, a pyridinium salt, and primary, secondary, and tertiary amino groups; anionic antistatic agents having anionic functional groups such as a sulfonate salt and a sulfate ester salt, a phosphonate and a phosphate ester salt; amphoteric antistatic agents such as an alkyl betaine and a derivative thereof, imidazoline and a derivative thereof, and alanine and a derivative thereof; and nonionic antistatic agents such an amino alcohol and a derivative thereof, glycerin and a derivative thereof, and a polyethylene glycol and a derivative thereof. For example, an ion conductive polymer obtained by polymerizing or copolymerizing a monomer having an ion conductive group of the cationic, anionic, or amphoteric antistatic agent, may be used. These may be used singly or in combination of two or more thereof.

### [Antiseptic Agent]

The antiseptic agent may be used mainly to enhance antisepsis power and bactericidal power to maintain antiseptic during long-term storage. Examples of the antiseptic agent include isothiazolone-based organosulfur compounds, benzisothiazolone-based organosulfur compounds, benzoic acids, and 2-bromo-2-nitro-1,3-propanediol.

### [Ultraviolet Absorber]

The ultraviolet absorber is an agent that has a protection effect against ultraviolet rays, and is a component that absorbs ultraviolet rays, converts them into infrared rays, visible rays, and the like, and emits them. Examples of the ultraviolet absorber include aminobenzoic acid derivatives, salicylic acid derivatives, silicic acid derivatives, benzophenone derivatives, azole-based compounds, and 4-t-butyl-4′-methoxybenzoylmethane.

### [Antibacterial Agent]

The antibacterial agent is a component that exhibits the effect of inhibiting bacteria from growing on fibers and further exhibits the effect of inhibiting generation of unpleasant odors derived from decomposition products of microorganisms. Examples of the antibacterial agents include, for example, cationic antibacterial agents such as a quaternary ammonium salt, bis-(2-pyridylthio-1-oxide) zinc, a polyhexamethylene biguanidine hydrochloride salt, 8-oxyquinoline, and a polylysine.

### [Deodorant]

Examples of the deodorant include cluster dextrin, methyl-β-cyclodextrin, 2-hydroxypropyl-β-cyclodextrin, monoacetyl-β-cyclodextrin, acylamidopropyl dimethylamine oxide, and an aminocarboxylic acid-based metal complex (the zinc complex of trisodium methylglycine diacetate described in WO2012/090580).

### [Amount of Other Component]

Each amount or the total amount of other components may be 0.1 parts by weight or more, 1 part by weight or more, 3 parts by weight or more, 5 parts by weight or more, 10 parts by weight or more, 15 parts by weight or more, 20 parts by weight or more, 50 parts by weight or more, 75 parts by weight or more, or 100 parts by weight or more, relative to 100 parts by weight of the liquid-repellent compound. Each amount of the total amount of other components may be 500 parts by weight or less, 300 parts by weight or less, 200 parts by weight or less, 100 parts by weight or less, 50 parts by weight or less, 40 parts by weight or less, 30 parts by weight or less, 20 parts by weight or less, 10 parts by weight or less, or 5 parts by weight or less, relative to 100 parts by weight of the liquid-repellent compound.

### <Production Method of Treated Textile Product or Paper Product>

A method for producing a product treated with the surface modifier in the present disclosure includes a treatment step of treating a substrate with the surface modifier described above.

The “treatment” refers to applying the surface modifier to a substrate by dipping, spraying, coating or the like. By the treatment, the active ingredient of the surface modifier, i.e., the liquid-repellent compound, is adhered to the inside and/or the surface of the substrate. Herein, the adhesion may be physical adhesion or chemical adhesion, and for example, the liquid-repellent compound may be physically or chemically modified (by reaction) onto a hydroxyl group of a substrate (for example, fiber, paper and glass).

### [Substrate]

Substrates to be treated with the surface modifier in the present disclosure are not limited, and are preferably a textile product or a paper product, and in particular, a paper product.

The surface modifier in the present disclosure imparts liquid-repellency to a substrate (e.g., fiber substrate, paper substrate), and may function as at least one selected from a water-repellent agent, an oil-repellent agent, an oil-resistant agent and a water-resistant agent. The substrate which has been treated with the surface modifier in the present disclosure, for example, is an oil-repellent paper or a water-repellent paper.

Examples of the substrate for textile products include animal and vegetable natural fibers such as cotton, linen, wool, and silk, synthetic fibers such as a polyamide, a polyester, a polyvinyl alcohol, a polyacrylonitrile, a polyvinyl chloride, and a polypropylene, and semi-synthetic fibers such as rayon and acetate, inorganic fibers such as a glass fiber, a carbon fiber, and an asbestos fiber, or blended fibers thereof. The textile products include a woven fabric, a knitted fabric, a nonwoven fabric, fabric in the form of clothing (for example, water-repellent garments, for example, a raincoat) and carpets, and a fiber, yarn and intermediate fiber product (for example, a sliver or a crude yarn) in a state of before being formed into fabric, may undergo treatment.

Examples of the substrate for paper products include, for example, bleached or unbleached chemical pulp such as kraft pulp or sulfite pulp, bleached or unbleached high-yield pulp such as groundwood pulp, mechanical pulp, or thermomechanical pulp, paper made from wastepaper pulp such as wastepaper of newspapers, magazines, and cardboard, and deinked wastepaper, a container made of paper, and a molded product made of paper. Specific examples of the paper products include, for example, a food packaging material, a food container, gypsum liner board base paper, coated base paper, medium-quality paper, a general liner and core, neutral pure white roll paper, a neutral liner, a rust-proof liner, and metal pasted paper, kraft paper, neutral printing writing paper, neutral coated base paper, neutral PPC paper, neutral thermal paper, neutral pressure-sensitive base paper, neutral inkjet paper and neutral information paper, and molded paper (mold container), and suitable examples thereof include the food packaging material and the food container.

A substrate to be treated with the surface modifier of the present disclosure is not limited to textile products or paper products, and it may also include, for example, stone, a filter (for example, an electrostatic filter), a dust-protective mask, fuel cell parts (for example, a gas diffusion electrode and a gas diffusion support), glass, wood, leather, fur, asbestos, brick, cement, metal and oxide, a ceramic product, a plastic, a painted surface, and a plaster.

When the substrate is glass, a glass product to be produced may be an optical member. A certain layer (or film), such as a hard coat layer or an antireflection layer, may be formed on the surface (outermost layer) of a glass substrate. The antireflection layer may be any of a single-layer antireflection layer and a multi-layer antireflection layer. Examples of inorganic substances usable in the antireflection layer include SiO₂, SiO, ZrO₂, TiO₂, TiO, Ti₂O₃, Ti₂O₅, Al₂O₃, Ta₂O₅, CeO₂, MgO, Y₂O₃, SnO₂, MgF₂, and WO₃. One of these inorganic substances may be used singly, or two or more may be used in combination (e.g., as a mixture). In the case of a multi-layer antireflection layer, SiO₂ and/or SiO is preferably used in the outermost layer thereof. When the article to be produced is an optical glass component for a touch panel, a part of the surface of the substrate (glass) may have a transparent electrode such as a thin film in which indium tin oxide (ITO), indium zinc oxide, or the like is used. The substrate, according to its specific configuration or the like, may have an insulating layer, an adhesive layer, a protecting layer, a decorated frame layer (I-CON), an atomizing film layer, a hard coating layer, a polarizing film, a phase difference film, a liquid crystal display module, or the like.

### [Treatment Method]

The surface modifier of the present disclosure can be applied to a substrate as a treatment agent (particularly a surface-treating agent) by a conventionally known method. The treatment method may be a method for dispersing the surface modifier in the present disclosure in an organic solvent or water, if necessary, to dilute it and allowing it to adhere to an inside of a substrate and/or on a surface thereof by a known method such as dip coating, spray coating, and foam coating. After drying, a product to which a solid component of the surface modifier has been adhered, is obtained. If necessary, the surface modifier of the present disclosure may be applied in combination of a suitable cross-linking agent, and curing may be carried out. If necessary, the surface modifier of the present disclosure can be further combined for use with various additives such as water- and/or oil-repellent agents, an anti-slip agent, an antistatic agent, a texture modifier, a softening agent, an antibacterial agent, a flame retarder, a coating material fixing agent, a wrinkle-resistant agent, a drying rate adjuster, a cross-linking agent, a film formation agent, a compatibilizer, an antifreezing agent, a viscosity modifier, an ultraviolet absorber, an antioxidant, a pH adjuster, an insect repellent, and an antifoaming agent. Examples of the various additives may be the same as those explained in the section “Other Component” described above. A concentration of the surface modifier in a treatment agent brought into contact with a substrate may be appropriately changed depending on its use, and may be 0.01 to 10% by weight, for example 0.05 to 5% by weight.

The surface modifier can be applied to a substrate by any of methods known for treating a substrate with liquid. The substrate may be immersed in the surface modifier, or solution may be adhered or sprayed onto the substrate. The treated substrate is preferably dried and cured by heating in order to develop liquid-repellency. The heating temperature may be, for example, 100° C. to 200° C., 100° C. to 170° C., or 100° C. to 120° C. Favorable performance can be obtained even by heating at lowered temperatures (for example, 100° C. to 140° C.) in the present disclosure. In the present disclosure, the heating time may be 5 seconds to 60 minutes, for example, 30 seconds to 3 minutes. When the textile product is paper, the paper may undergo coating, or solution may be adhered or sprayed onto the paper, or the solution may be mixed with pulp slurry before papermaking to undergo treatment. The treatment may be external addition treatment or internal addition treatment. Alternatively, the surface modifier may be applied to a textile product by a cleaning method, and for example, it may be applied to a textile product in, for example, washing application or a dry cleaning method.

### [Paper Product Treatment]

Examples of paper substrates include paper, a container made of paper, and a molded product made of paper (for example, a pulp mold). The liquid-repellent compound of the present disclosure adheres well to the paper substrate.

The paper can be produced by a conventionally known papermaking method. An internal addition treatment method in which the surface modifier is added to pulp slurry before papermaking, or an external addition treatment method in which the surface modifier is applied to paper after papermaking, can be employed.

A size press used in an external addition treatment method, can be divided into the following types depending on a coating method.

One coating method involves supplying a coating liquid (size liquid) to a nip portion formed by passing paper between two rubber rolls, creating a pool of the coating liquid called a pond, and allowing the paper to pass through this pool to coat both sides of the paper with the size liquid, which is a method employed for a so-called pound-type two-roll size press. Another coating method is a method used for a gate roll type size press in which a size liquid is applied by a surface transfer type, and a rod metering type size press. In the pound-type two-roll size press, the size liquid easily penetrates into an inside of paper, and in the surface transfer type, a size liquid component is likely to stay on a surface of the paper. In the surface transfer type, a coating layer is likely to stay on a surface of paper more than in the pound-type two-roll size press, and the amount of coating layer formed on the surface is more than in the pound-type two-roll size press. In the present disclosure, even in the case of using the former pound-type two-roll size press, performance can be imparted to paper. After having been lightly dried at room temperature or elevated temperature, the paper treated in such a manner is arbitrarily accompanied by heat treatment that can have a temperature range of up to 300° C., for example up to 200° C., and particularly the temperature range of 80° C. to 180° C., depending on the nature of the paper, as a result of which excellent oil resistance, water resistance, and the like can be exhibited.

The internal addition treatment method may refer to a treatment method for adding the surface modifier to pulp slurry before papermaking. The internal addition treatment method may include, but is not limited to, one or more of a step of adding the surface modifier to pulp slurry and stirring and mixing them; a step of sucking and dehydrating the pulp composition prepared in the step through a net-like body of predetermined shape and depositing the pulp composition then to form a pulp mold intermediate; and a step of molding and drying the pulp mold intermediate by using a heated molding mold to obtain paper, a container made of paper, and a molded product made of paper. After having been lightly dried at room temperature or elevated temperature, the treated paper may be arbitrarily subjected to heat treatment, depending on the nature of the paper. Temperature of the heat treatment may be 150° C. or higher, 180° C. or higher, or 210° C. or higher, and may be 300° C. or lower, 250° C. or lower, or 200° C. or lower, particularly 80° C. to 180° C. Carrying out the heat treatment in such a temperature range enables exhibiting, for example, excellent oil resistance and water resistance.

The present disclosure can be used, for example, in gypsum liner board base paper, coated base paper, medium-quality paper, a general liner and core, neutral pure white roll paper, a neutral liner, a rust-proof liner, and metal pasted paper, and kraft paper. The present disclosure can also be used, for example, in neutral printing writing paper, neutral coated base paper, neutral PPC paper, neutral thermal paper, neutral pressure-sensitive base paper, neutral inkjet paper and neutral information paper.

As pulp raw materials, any of bleached or unbleached chemical pulp such as kraft pulp or sulfite pulp; bleached or unbleached high-yield pulp such as groundwood pulp, mechanical pulp, or thermomechanical pulp; and wastepaper pulp such as wastepaper of newspapers, magazines, and cardboard, or deinked wastepaper, can be used. Moreover, a blend of the aforementioned pulp raw material and a synthetic fibers such as asbestos, a polyamide, a polyimide, a polyester, a polyolefin, or a polyvinyl alcohol, can also be used.

A sizing agent can be added to improve water resistance of paper. Examples of the sizing agent are a cationic sizing agent, an anionic sizing agent, and a rosin-based sizing agent (for example, an acidic rosin-based sizing agent and a neutral rosin-based sizing agent). The amount of sizing agent may be 0.01 to 5% by weight relative to pulp.

For paper, as chemicals for papermaking used to such an extent that they are usually used, if necessary, paper strengthening agents such as starch, modified starch, carboxymethyl cellulose, and a polyamide polyamine-epichlorohydrin resin, and additives used in production of paper, such as an agglomerating agent, a fixing agent, a yield improver, a dye, a fluorescent dye, a slime control agent, and an antifoaming agent, can be used. Starch and modified starch are preferably used. If necessary, paper can be coated with the surface modifier together with starch, a polyvinyl alcohol, a dye, a coating color, an anti-slip agent, or the like, for example, by a size press, a gate roll coater, a bill blade coater, a calender, or the like.

In external addition, the amount of liquid-repellent compound contained in a coating layer is preferably 0.01 to 2.0 g/m² and particularly 0.1 to 1.0 g/m². The coating layer is preferably formed of the surface modifier and starch and/or modified starch. The solid content of the surface modifier for paper in the coating layer is preferably 2 g/m² or less.

In internal addition, the surface modifier is preferably mixed with pulp so that the amount of surface modifier is 0.01 to 50 parts by weight or 0.01 to 30 parts by weight, for example 0.01 to 10 parts by weight and particularly 0.2 to 5.0 parts by weight, relative to 100 parts by weight of pulp that forms paper.

In external addition, even when employing a so-called pound type two-roll size press treatment in which a treatment liquid is stored between rolls, and base paper is passed through the treatment liquid between the rolls at an arbitrary roll speed and nip pressure, oil-repellency can be imparted to paper.

In external addition treatment, a paper substrate may contain additives such as a sizing agent, a paper strengthening agent, an agglomerating agent, or yield improver or a coagulant. The additives may be nonionic, cationic, anionic or amphoteric. An ionic charge density of the additive may be −10,000 to 10,000 μeq/g, preferably −4,000 to 8,000 μeq/g, and more preferably −1,000 to 7,000 μeq/g. The additive (for example, a sizing agent, a paper strengthening agent, an agglomerating agent, a yield improver, or a coagulant; for example, solid content or active ingredient) may be generally used in an amount of 0.1 to 10% by weight (for example, 0.2 to 5.0% by weight) relative to pulp. In the case of a paper substrate containing a cationic additive (for example, a sizing agent, a paper strengthening agent, an agglomerating agent, a yield improver, or a coagulant), the surface modifier may be anionic; in the case of a paper substrate containing an anionic additive, the surface modifier may be cationic; however, the surface modifier is not limited thereto.

In internal addition treatment, pulp slurry having a pulp concentration of 0.5 to 5.0% by weight (for example, 2.5 to 4.0% by weight) preferably undergo papermaking. The pulp slurry can be added with an additive (for example, a sizing agent, a paper strengthening agent, an agglomerating agent, a yield improver, or a coagulant) and the liquid-repellent compound. Examples of the additive (for example, a sizing agent, a paper strengthening agent, an agglomerating agent, a yield improver, or a coagulant) include an alkyl ketene dimer, an alkenyl succinic anhydride, a styrenic polymer (styrene/maleic acid polymer, styrene/acrylic acid-based polymer), a urea-formaldehyde polymer, a polyethyleneimine, a melamine-formaldehyde polymer, a polyamideamine-epichlorohydrin polymer, a polyacrylamide-based polymer, a polyamine-based polymer, a polydiallyldimethylammonium chloride, an alkylamine·epichlorohydrin condensate, a condensate of alkylene dichloride and polyalkylene polyamine, a dicyandiamide·formalin condensate, a dimethyldiallylammonium chloride polymer, and an olefin/maleic anhydride polymer.

In internal addition treatment, the paper substrate may contain an additive such as a sizing agent, a paper strengthening agent, an agglomerating agent, a yield improver, or a coagulant. The additive may be nonionic, cationic, anionic, or amphoteric. The ionic charge density of the additive may be −10,000 to 10,000 μeq/g, preferably −4,000 to 8,000 μeq/g, and more preferably-1,000 to 7,000 μeq/g. The additive (for example, a sizing agent, a paper strengthening agent, an agglomerating agent, a yield improver, or a coagulant; for example, solid content or active ingredient) may be generally used in an amount of 0.1 to 10% by weight (for example, 0.2 to 5.0% by weight) relative to pulp. In the case of a paper substrate containing a cationic additive (for example, a sizing agent, a paper strengthening agent, an agglomerating agent, a yield improver, or a coagulant), the surface modifier may be anionic; in the case of a paper substrate containing an anionic additive, the surface modifier may be cationic; however, the surface modifier is not limited thereto.

### [Pretreatment of Fiber Product]

The fiber product may be pretreated before being treated with the surface modifier of the present disclosure. Pretreatment of the fiber product enables imparting excellent fastness to a fiber product after treated with the surface modifier.

Examples of the pretreatment of fiber product include, for example, cationization treatment such as reaction with a reactive quaternary ammonium salt, anionization treatment such as sulfonation, carboxylation, and phosphorylation, acetylation treatment after the anionization treatment, benzoylation treatment, carboxymethylation treatment, graft treatment, tannic acid treatment, and polymer coating treatment.

A method for pretreating the fiber product is not limited, but the fiber product can be pretreated by a conventionally known method. A method for dispersing a pretreatment liquid in an organic solvent or water, if necessary, to dilute the pretreatment liquid and adhering it to an inside of the fiber product and/or on a surface thereof and drying the liquid by a known method such as dip coating, spray coating, or foam coating, may be employed. The pH, temperature, etc. of the pretreatment liquid may be adjusted according to an extent of treatment desired. As an example of the method for pretreating a fiber product, a method for pretreating a fiber product with the treatment agent described above will be described in detail.

The pretreatment method of a fiber product may involve a step of imparting a fiber with one or more functional groups (hereinafter sometimes referred to as “specific functional groups”) selected from the group consisting of the monovalent group represented by —SO₃M¹ (wherein M¹ represents a monovalent cation) or the monovalent group represented by —COOM² (wherein M² represents a monovalent cation), and the monovalent group represented by —O—P(O)(OX¹)(OX²) (wherein X¹ and X² each independently represent a hydrogen atom or an alkyl group having 1 to 22 carbon atoms).

Examples of M¹ include H, K, Na, or an ammonium ion which may have a substituent. Examples of M² include H, K, Na, or an ammonium ion which may have a substituent. When X¹ or X² is an alkyl group, it is preferably an alkyl group having 1 to 22 carbon atoms and more preferably an alkyl group having 4 to 12 carbon atoms.

A fiber containing the above specific functional group (hereinafter sometimes referred to as a “functional group-containing fiber”) can be prepared, for example, by the following method.
(i) A compound having the above specific functional group is allowed to adhere to a fiber material. The adhesion of the compound may be in a condition such that a portion of the compound and a portion of the fibers are chemically bonded as long as the above specific functional groups remain in a sufficient amount.
(ii) A fiber is prepared by directly introducing the above specific functional group into the material constituting the fiber.

In the case of (i), for example, a functional group-containing fiber can be obtained by treating the fiber material with a pretreatment liquid containing one or more compounds having the above specific functional group, namely, by the step of introducing the functional group.

Materials used for the fiber material, are not limited, and examples thereof include natural fibers such as cotton, linen, silk, and wool, semi-synthetic fibers such as rayon and acetate, synthetic fibers such as a polyamide (nylon, etc.), a polyester, a polyurethane, and a polypropylene, composite fibers thereof, blended fibers, and the like. A form of the fiber material may be any form such as a fiber (tow, sliver, etc.), a yarn, a knitted fabric (including an interknitted fabric), a woven fabric (including an interwoven fabric), or a nonwoven fabric.

In the present embodiment, from the viewpoint of improving water-repellency of the obtained textile product, a fiber material containing a polyamide and a polyester as raw materials, is preferably used, and in particular, nylon such as nylon 6, or nylon 6,6, a polyester such as a polyethylene terephthalate (PET), a polytrimethyl terephthalate, or polylactic acid, and blended fibers containing these, are preferably used.

A Phenolic polymer can be used as the compound having —SO₃M¹ described above. Examples of such a phenolic polymer include that containing at least one of compounds represented by the following general formula:

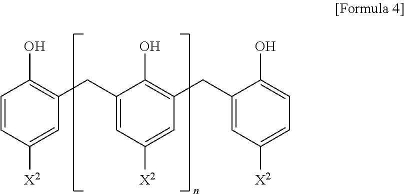

[wherein X² represents —SO₃M³, wherein M³ represents a monovalent cation, or a group represented by the following general formula, and n is an integer of 20 to 3,000.]

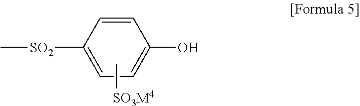

[wherein M⁴ represents a monovalent cation.].

Examples of M³ includes H, K, Na or an ammonium ion that may have a substituent.

Examples of M⁴ includes H, K, Na or an ammonium ion which may have a substituent.

The compounds represented by the general formula above may be, for example, formalin condensates of phenol sulfonic acid and formalin condensates of sulfonated bisphenol S.

Examples of the compound having —COOM² above include a polycarboxylic acid-based polymer.

As the polycarboxylic acid-based polymer, for example, a polymer synthesized by a conventionally known radical polymerization method using acrylic acid, methacrylic acid, maleic acid, or the like as a monomer, or a commercially available polymer, can be used.

A method for producing the polycarboxylic acid-based polymers may include, for example, adding a radical polymerization initiator to an aqueous solution of the aforementioned monomer and/or salt thereof and heating and reacting the mixture at 30 to 150° C. for 2 to 5 hours. At this time, an aqueous solution of the above monomer and/or salt thereof may be added with aqueous solvents such as alcohols such as methanol, ethanol, and isopropyl alcohol, and acetone. Examples of the radical polymerization initiator include persulfates such as potassium persulfate, sodium persulfate, and ammonium persulfate, redox polymerization initiators in combination of the persulfate and sodium bisulfite or the like, hydrogen peroxide, and a water-soluble azo-based polymerization initiator. These radical polymerization initiators may be used singly or in combination of two or more thereof. Furthermore, a chain transfer agent (for example, octyl thioglycolate) may be added upon radical polymerization for the purpose of adjusting the degree of polymerization.

In addition to the aforementioned monomers, a copolymerizable monomer can be used for radical polymerization. Examples of the copolymerizable monomer include vinyl-based monomers such as ethylene, vinyl chloride, and vinyl acetate, an acrylamide, acrylates, and methacrylates. The acrylates and methacrylates preferably have a hydrocarbon group having 1 to 3 carbon atoms, which may have a substituent such as a hydroxyl group. Examples of such acrylates or methacrylates include methyl acrylate, methyl methacrylate, ethyl acrylate, ethyl methacrylate, 2-hydroxyethyl acrylate, 2-hydroxyethyl methacrylate, propyl acrylate, propyl methacrylate, and the like. These copolymerizable monomers may be used singly or in combination of two or more thereof.

A carboxyl group in the polycarboxylic acid-based polymer may be free or may be neutralized with an alkali metal, an amine-based compound, or the like. Examples of the alkali metal include sodium, potassium, lithium, and the like, and examples of the amine-based compound include ammonia, monoethanolamine, diethanolamine, triethanolamine, and the like.

The weight average molecular weight of the polycarboxylic acid-based polymer is preferably 1,000 to 20,000 and more preferably from 3,000 to 15,000, from the viewpoint of favorable water-repellency of the resulting textile product.

As the polycarboxylic acid-based polymer, commercially available products such as “Neocrystal 770” (trade name, manufactured by NICCA CHEMICAL CO., LTD.) and “Ceropol PC-300” (trade name, manufactured by Sanyo Chemical Industries, Ltd.) can be used.

Examples of the compound having —O—P(O)(OX¹)(OX²) as described above include phosphoric acid ester compounds represented by the following general formula:

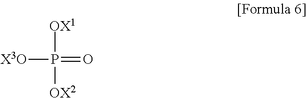

[wherein, X¹ or X² is the same as defined above, and X³ represents an alkyl group having 1 to 22 carbon atoms.]

As the aforementioned phosphoric acid ester compound, phosphoric acid monoesters, diesters and triesters, and mixtures thereof can be used in which the alkyl ester moiety is an alkyl group having 1 to 22 carbon atoms.

In view of favorable water-repellency of the textile products to be obtained, lauryl phosphoric acid ester and decyl phosphoric acid ester are preferably used.

As the phosphoric acid ester compound, for example, a commercially available product such as “Phosphanol ML-200” (trade name, manufactured by TOHO Chemical Industry Co., Ltd.) can be used.

A pretreatment liquid containing one or more of the compounds having the aforementioned specific functional group can be, for example, an aqueous solution of the compound described above. The pretreatment liquid may also contain an acid, alkali, surfactant, chelating agent, and the others.

Examples of the method for treating a fiber material with the above pretreatment liquid include padding treatment, dip treatment, spray treatment, and coating treatment. Examples of padding treatment include the method involving using the padding apparatus as described on pages 396 to 397 of Seni Sensyoku Kako Jiten (in Japanese; Fiber-dyeing process dictionary) (published by THE NIKKAN KOGYO SHIMBUN, LTD., 1963) and pages 256 to 260 of Irozome Kagaku (in Japanese; dyeing chemistry) III (published by Jikkyo Shuppan Co., Ltd., 1975). Examples of the coating treatment include the method involving using a coating machine as described on pages 473 to 477 of Sensyoku Shiage Kiki Soran (in Japanese; Comprehensive guide to dyeing and finishing machines) (published by Fiber Japan CO., LTD., 1981). Examples of the dip treatment include the method involving using a batch type dyeing machine as described in pages 196 to 247 of Sensyoku Shiage Kiki Soran (in Japanese) (published by Fiber Japan CO., LTD., 1981), and for example, a jet dyeing machine, air flow dyeing machine, drum dyeing machine, wince dyeing machine, washer dyeing machine, and cheese dyeing machine can be used. Examples of the spray treatment includes a method involving using an air spray that nebulizes and sprays a treatment liquid by compressed air, or an air spray by hydraulic pressure nebulization system. In this case, the concentration of the treatment liquid and treatment conditions of heat treatment after application can be adjusted appropriately, taking into consideration various conditions such as their purposes and performance. Moreover, in a case in which the pretreatment liquid contains water, it is preferably dried to remove water after the pretreatment liquid has been allowed to adhere to the fiber material. The drying method are not limited, and either a dry heat method or a wet heat method may be employed. Drying temperatures are also not limited, and for example, drying may be carried out at room temperature to 200° C. for 10 seconds to several days. Heat treatment at a temperature of 100 to 180° C. for about 10 seconds to 5 minutes may be carried out after the drying, as necessary.

In a case in which a fiber material is such that it is to be dyed, treatment with the pretreatment liquid may be carried out before dyeing or in the same bath as in dyeing, but in the case of carrying out reduction soaping, a compound with the above specified functional group (for example, a phenolic polymer compound or the like) adsorbed in the process may fall off, and therefore the treatment with the pretreatment liquid is preferably carried out after the reduction soaping after dyeing.

The treatment temperature in the dip treatment can be 60 to 130° C. The treatment time can be 5 to 60 minutes.

The step of introducing a functional group by the pretreatment liquid is preferably carried out so that the amount of compound having the above specified functional group adhered is 1.0 to 7.0 parts by weight relative to 100 parts by weight of a fiber material. Within this range, both durable water-repellency and texture can be achieved at a high level.

The pH of the pretreatment liquid may be adjusted to less than 7, for example 3 to 5. The pH adjustment can be carried out by using a pH adjuster such as acetic acid or malic acid.

A salt can be used in combination with the pretreatment liquid to adsorb the compound having the aforementioned specific functional group effectively onto the fiber material by a salting effect. Examples of the salt that can be used include, for example, sodium chloride, sodium carbonate, ammonium sulfate, and sodium sulfate.

In the step of introducing the functional group by the pretreatment liquid, an excess amount of the compound having the aforementioned specific functional group, which has been given by the treatment, is preferably removed. Examples of the removal method include washing with water. Sufficient removal can avoid inhibition of development of water-repellency in the subsequent water-repellent treatment, and additionally, the textile product to be obtained has the favorable texture. The resulting functional group-containing fiber is preferably fully dried prior to contact with the treatment agent described above.

Examples of (ii) the fiber in which the aforementioned specific functional group has been introduced directly into the material forming the fiber include a cation-dyeable polyester (CD-PET).

In view of favorable water-repellency of the textile products to be obtained, the functional group-containing fiber preferably has a zeta potential of its surface of −100 to −0.1 mV and more preferably −50 to −1 mV. The zeta potential of the fiber surface can be measured, for example, using a zeta potential and particle size measurement system, ELSZ-1000ZS (manufactured by Otsuka Electronics Co., Ltd.).

Embodiments have been described above, but it will be understood that various modifications can be made to embodiments and details without departing from the spirit and the scope of the claims.

### EXAMPLES

Hereinafter, the present disclosure will be described in detail with reference to Examples, but the present disclosure is not limited to these Examples.

A compound A1 and a compound A2 are each the liquid-repellent compound of the present disclosure. A compound Z1 and a compound Z2 are known compounds, and synthesis procedures therefor are omitted.

### <Synthesis of Compound A1>

### First Step

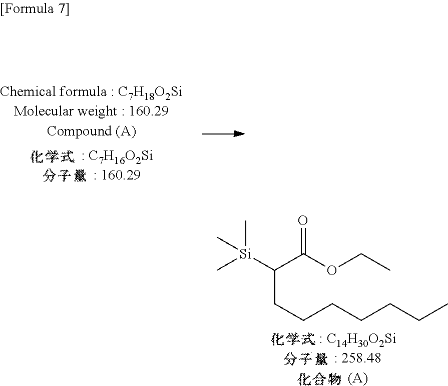

A reaction container was charged with 1.06 M LDA in n-hexane-THF (177 mL) and THE, and the resultant was stirred at −70° C. Subsequently, ethyl (trimethylsilyl)acetate (30 g)/THF was dropped at the same temperature. Then, HMPT (16.8 g) and 1-iodoheptane (42.3 g) were dropped while the internal temperature was kept at −60° C. or less. After that, the temperature was increased to room temperature. The reaction solution was subjected to liquid separation treatment and dehydration treatment, and then concentrated and subjected to silica gel column purification, giving 42 g of the compound (A).

### Second Step

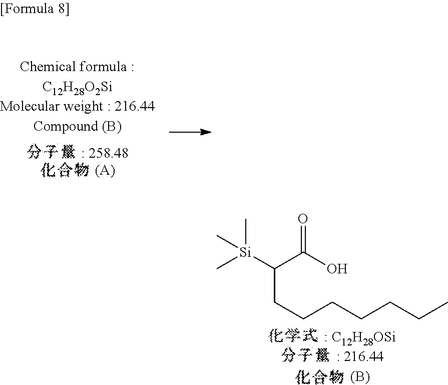

A reaction container was charged with Et20, and LiAlH₄ (25 g) was added thereto with slight ice-cooling. After the temperature was increased to room temperature, the compound (A) (40 g)/Et20 was dropped. The reaction solution was subjected to liquid separation treatment and dehydration treatment, and then concentrated and subjected to silica gel column purification, giving 22 g of the compound (B).

### Third Step

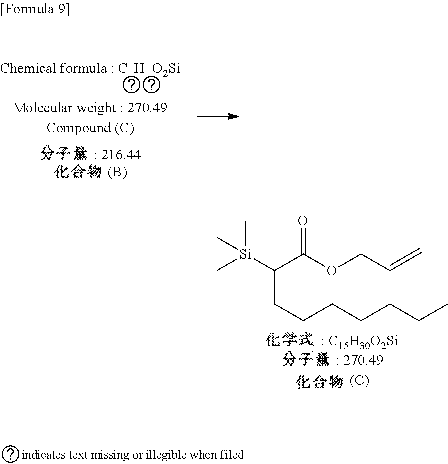

A reaction container was charged with the compound (B) (20 g)/THF and EtN (9.4 g), and the resultant was ice-cooled. To this solution, acryloyl chloride (8.36 g) was dropped. After that, the temperature was increased to room temperature. The reaction solution was subjected to liquid separation treatment and dehydration treatment, and then concentrated and subjected to silica gel column purification, giving 12 g of the compound (C).

### Fourth Step (Polymerization Step)

Into a reaction container, 1.5 g of the compound (C) was put, toluene was added to dissolve the compound (C) therein, the inside of a reaction flask was purged with nitrogen, and 1.2 mol % of 2,2-azobisisobutyronitrile was then added to react at 69° C. overnight, giving a crude polymer. The crude polymer was reprecipitated to give a purified polymer (a polymer of the compound A1) as a solid.

The weight average molecular weight of the polymer of the compound A1 was found to be 32,000 (in terms of polystyrene).

### <Synthesis of Compound A2>

### First Step

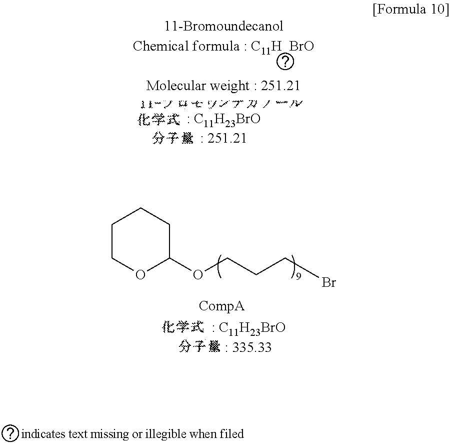

A reaction container was charged with 11-bromoundecanol (25 g), dichloromethane, and 3,4-dihydro-2H-pyran (9.21 g), and the resultant was stirred at room temperature. Then, pyridinium para-toluenesulfonate (5.0 g) was gradually added. After completion of the addition, stirring was continued at room temperature. The resultant was subjected to liquid separation treatment and dehydration treatment, and then concentrated to give a crude product, which was purified with a silica gel column, giving 27 g of compA as the target product.

### Second Step

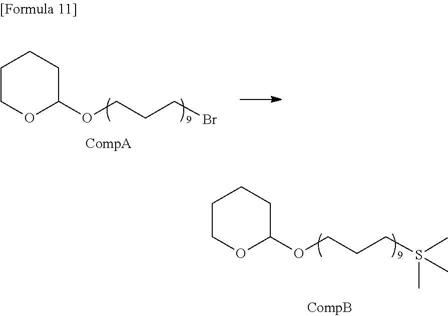

A reaction container was charged with THE and CompA (1.0 g), and the resultant was stirred at −70° C. To this solution, 1.5 M t-BuLi (4.0 mL) was gradually dropped. After completion of the dropping, the temperature was increased to −10° C. to 0° C. The resultant was again cooled to −70° C., and TMS chloride (0.35 g) was dropped. After completion of the dropping, the temperature was increased to room temperature. The reaction liquid was subjected to liquid separation treatment and dehydration treatment, and then concentrated to give a crude product, which was purified with a silica gel column, giving 1.0 g of compB as the target product.

### Third Step

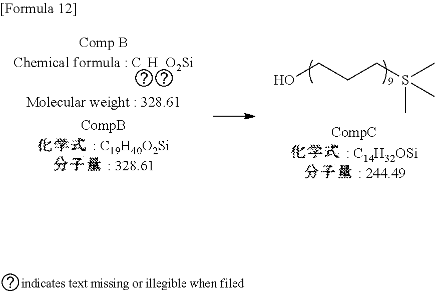

### Reagents Used

(1) CompB: 1.0 g (32 mmol)
(2) montmorillonite K10: 1.0 g
(3) dehydrated methanol: 10 mL

### Reaction Conditions

A reaction container was charged with CompB (1.0 g) and methanol, and the resultant was stirred at room temperature. To this reaction solution, montmorillonite K10 (1.0 g) was added, and the resultant was stirred with heating at 40° C. Insoluble matters were removed by filtration, and the filtrate was then concentrated under reduced pressure. The crude product was subjected to silica gel column purification and Kugelrohr distillation purification, giving 0.6 g of compC as the target product.

### Fourth Step

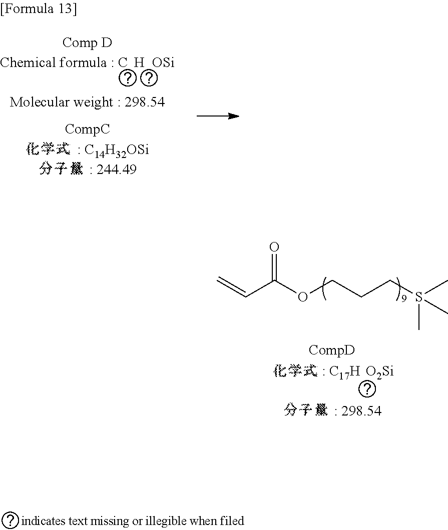

To a reaction container, CompC (0.3 g), triethylamine (0.14 g), and THE were added, and the resultant was stirred at 0° C. To this solution, acryloyl chloride (0.12 g) was dropped. After the dropping, the temperature was increased to room temperature. The reaction liquid was subjected to liquid separation treatment and dehydration treatment, and then concentrated, giving 0.3 g of compD as the target product.

### Fifth Step (Polymerization Step)

Into a reaction container, 0.3 g of compD was put, toluene wad added to dissolve compD therein, the inside of a reaction flask was purged with nitrogen, and 1.2 mol % of 2,2-azobisisobutyronitrile was then added to react at 69° C. overnight, giving a crude polymer. The crude polymer was reprecipitated to give a purified polymer (a polymer of the compound A2) as a solid.

The weight average molecular weight of the polymer of the compound A2 was found to be 28,000 (in terms of polystyrene).

### <Test Method>

### {Evaluation of Water-Repellency: Measurement of Contact Angle of Water}

Contact angles of water were measured for the polymers (homopolymers) obtained from the compounds A1, A2, Z1, and Z2. Specifically, for each of the polymers, a solution containing 1% by mass of the polymer in chloroform was prepared, this solution was placed on a silicon substrate, and spin coating was performed at 2,000 rpm for 25 seconds to produce a film. Water was dropped on the resulting film, and the contact angle was measured. Measurement of contact angles was conducted for 2 μL of water with a contact angle measurement apparatus (manufactured by Kyowa Interface Science Co., Ltd.) under an environment at 25° C. Table 1 shows the measurement results for the contact angles of water (°).

TABLE 1

| Compound | Contact angle of water (°) | ΔG(kcal/mol) |
|---|---|---|
| A1 | 105 | −1.35 |
| A2 | 99.4 | −1.46 |
| Z1 | 82.6 | −2.80 |
| Z2 | 90.4 | −1.54 |

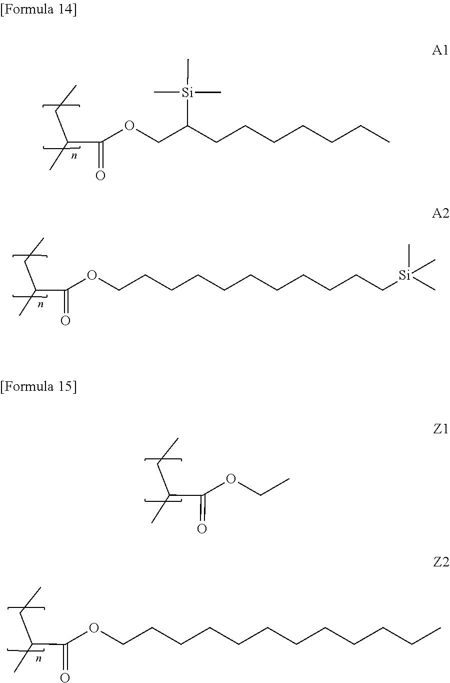

Referring to Table 1, the polymers of the compounds A1 and A2 exhibited larger contact angles than the polymers of the compounds Z1 and Z2, thus showing sufficiently high water-repellency.

It is understood that contact angles of water and ΔG show correlation, and that values closer to 0 indicate being more hydrophobic.

### (Evaluation of Water-Repellency: Calculation of ΔG by Simulation)

For a polymer (homopolymer) obtained from a compound, the solvation energy for water, ΔG (kcal/mol), can be calculated by simulation. Specifically, ΔG is calculated by using a proper computer (including an input device, an output device, a CPU, and a memory) with reference to FIG. 1 through the following steps S1 to S4.

### Step S1

Water (small molecules) and a polymer (homopolymer) are defined as a solute and a solvent, respectively, and data for the system are acquired in step S1. A system is a target solution system consisting of a solute and a solvent. The data contains information on the types of multiple atoms constituting the solute and solvent and the fields of force of the atoms, and further contains the initial positions of the atoms, the initial velocities of the atoms, and so on. For the solvent molecules (polymer), information on the class of the polymer such as information on the homopolymerization system, the crystallinity, and the molecular weight is also contained in those data. Furthermore, conditions when solvent molecules (polymer) absorb solute molecules (water), such as temperature and pressure, are also contained in those data.

### Step S2

Subsequently, the motions of atoms contained in each of the solute and the solvent are calculated by molecular dynamics simulation. Thereby, the coordinates of the atoms are acquired at multiple times from the start to end of the calculation.

### Step S3

Subsequently, on the basis of the coordinates of the atoms at different times, the energy distribution function for the solute and solvent is calculated, which is generated from the following equation.

$$\begin{matrix}[ Expression 1 ] & \\ ρ ( ε ) = {\sum }_{i} δ ( ε - v ( ϕ , x i ) ) & ( c )\end{matrix}$$

In the equation,
ε is the interaction energy of the solute and solvent,
ρ is the distribution function,
ψ is the coordinates of the solute,
xi is the coordinates of the i-th solvent molecule,
ν(ψ, xi) is the interaction potential of the solute and solvent, and
δ is the delta function.

The equation (c) shows a distribution function, ρ, with the interaction energy of solute and solvent, ε, as the abscissa, and indicates the instantaneous distribution of the solvent around the solute. That is, the equation (c) represents the histogram of the interaction energy of a pair of solute and solvent at an instantaneous arrangement in a target system. Solute molecules and solvent molecules are regarded as one unit as a whole by focusing on the interaction energy without directly handling details of the molecular structures. Calculation is performed with the equation (c) at each instantaneous arrangement sampled to give the statistical mean (the mean of (c) for all instances), from which the energy distribution function (<ρ>, the statistical mean of the distribution function, ρ) is determined. This energy distribution function is calculated only for states “before” and “after” introduction of solute to solvent. Accordingly, calculation of the energy distribution function corresponds to execution of molecular dynamics simulation only for states “before” and “after” introduction of “solute” to “solvent”.

### Step S4

Subsequently, the solvation free energy, ΔG, is calculated with the energy distribution function calculated in step S3 and a free-energy functional. Specifically, the energy distribution function calculated in step S3 is substituted into a free-energy functional prepared in advance. The free-energy functional is for approximately deriving solvation free energy from an energy distribution function. A free-energy functional formularized in JACS, 1994, 116, 8952./Christopher A. Willoughby and Stephen L. Buchwald is used.

Through the steps, solvation energy for water, ΔG (kcal/mol), was calculated for the polymers (homopolymers) obtained from the compounds A1, A2, and Z. The calculation results for ΔG are collectively shown in Tables 2 to 4.

TABLE 2
Variation of solvation energy, ΔG, with bonding position of alkylsilyl

| | | | Si(R³)₃ | | | | | | | | |
|---|---|---|---|---|---|---|---|---|---|---|---|
| | | Linking | | | Length | Length of side chain | | | | | |
| No. | Core | group X | Position | Number | of R3- | 4 | 9 | 11 | 12 | 18 | 30 |
| 1 | Linear acryl | | | | | −2.245 | −1.640 | −1.600 | −1.544 | −1.317 | −0.954 |
| | (Comparative | | | | | | | | | | |
| | Example) | | | | | | | | | | |
| 2 | Acryl | C(═O)O | end | 1 | 1 | −1.710 | −1.461 | −1.462 | −1.429 | −1.240 | −0.889 |
| 3 | | | center | 1 | 1 | | −1.259 | −1.228 | | −1.181 | −0.878 |
| 4 | | | position 2 | 1 | 1 | −1.840 | −1.347 | −1.160 | −1.166 | −1.110 | −0.801 |
| 5 | | | position 1 | 1 | 1 | −1.530 | −1.122 | −1.102 | | −1.067 | −0.768 |

TABLE 3
Variation of solvation energy, ΔG, with length of alkyl group of alkylsilyl
group and number of bonded alkylsilyl groups in side chain side

| | | | Si(R³)₃ | | | Length of |
|---|---|---|---|---|---|---|
| | | Linking | | | Length of | side chain |
| No. | Core | group X | Position | Number | R3- | 9 |
| 1 | Linear acryl | | | | | −1.640 |
| | (Comparative | | | | | |
| | Example) | | | | | |
| 2 | Acryl | C(═O)O | end | 1 | 1 | −1.461 |
| 6 | | | | 1 | 2 | −1.209 |
| 7 | | | | 1 | 4 | −1.088 |
| 5 | | | position 1 | 1 | 1 | −1.122 |
| 8 | | | | 1 | 2 | −0.955 |
| 9 | | | | 1 | 4 | −0.477 |
| 10 | | | position | 2 | 1 | −0.892 |
| | | | 1 + end | | | |

TABLE 4
Variation of solvation energy, ΔG, with core type

| | | | | | | Length |
|---|---|---|---|---|---|---|
| | | | Si(R³)₃ | | | of side |
| | | Linking | | | Length | chain |
| No. | Core | group X | Position | Number | of R3- | 9 |
| 1 | Linear acryl | | | | | −1.640 |
| | (Comparative | | | | | |
| | Example) | | | | | |
| 2 | Acryl | C(═O)O | end | 1 | 1 | −1.461 |
| 3 | | | center | 1 | 1 | −1.259 |
| 4 | | | position 2 | 1 | 1 | −1.347 |
| 5 | | | position 1 | 1 | 1 | −1.122 |
| 11 | Citric acid | C(═O)O | no TMS | | | −2.398 |
| 12 | | | end | 1 | 1 | −2.015 |
| 13 | | | position 2 | 1 | 1 | −1.830 |
| 14 | | | position 1 | 1 | 1 | −1.565 |
| 15 | | C(═O)NH | no TMS | | | −4.271 |
| 16 | | | end | 1 | 1 | −3.540 |
| 17 | | | position 2 | 1 | 1 | −3.110 |
| 18 | | | position 1 | 1 | 1 | −2.841 |
| 19 | Monoglycerol | C(═O)O | no TMS | | | −2.580 |
| 20 | | | end | 1 | 1 | −2.211 |
| 21 | | | position 2 | 1 | 1 | −2.000 |
| 22 | | | position 1 | 1 | 1 | −1.816 |
| 23 | | C(═O)NH | no TMS | | | −4.356 |
| 24 | | | end | 1 | 1 | −4.066 |
| 25 | | | position 2 | 1 | 1 | −3.221 |
| 26 | | | position 1 | 1 | 1 | −3.431 |

Tables 2 to 4 show that the compounds having an alkylsilyl group, irrespective of their cores, exhibited higher values of ΔG than the compounds having no alkylsilyl group. From this, it is understood that high water-repellency is successfully obtained by imparting an alkylsilyl group. It is understood that higher water-repellency is desirably obtained as the position of an alkylsilyl group is closer to a linking group, and that higher water-repellency is desirably obtained as the length of R³ of an alkylsilyl group is longer.

It is understood that higher hydrophobicity is obtained as the number of alkylsilyl groups is larger.

The surface modifier of the present disclosure can be used for various applications in which liquid repellency (in particular, water-repellency) is required. In addition, the surface modifier of the present disclosure can be used for imparting liquid repellency (in particular, water-repellency) to textile products and the like.

The present disclosure includes the following embodiments.

### [Item 1]

A surface modifier comprising a liquid-repellent compound having a Z group represented by the following formula:

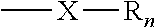

wherein X is a direct bond or a 1+n valent group,
R is independently at each occurrence an aliphatic hydrocarbon group having 4 or more and 40 or less carbon atoms, having at least one alkylsilyl group, and optionally having a substituent, and
n is 1 or more and 3 or less,
wherein the alkylsilyl group is represented by the following formula:

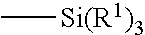

wherein R¹ is each independently a hydrogen atom or an aliphatic hydrocarbon group having 1 to 10 carbon atoms and optionally having a substituent, and at least one R¹ is an aliphatic hydrocarbon group having 1 or more and 10 or less carbon atoms and optionally having a substituent.

### [Item 2]

The surface modifier according to item 1, wherein the liquid-repellent compound has a solvation free energy of −1.50 kcal/mol or more.

### [Item 3]

The surface modifier according to any one of items 1 to 3, wherein the aliphatic hydrocarbon group as R has 4 or more and 30 or less carbon atoms.

### [Item 4]

The surface modifier according to any one of items 1 to 4, wherein when the carbon atom directly bonded to X among the carbon atoms of the aliphatic hydrocarbon group as R is defined to be at position 1, the alkylsilyl group is bonded to at least one carbon atom at position 1 to position N/2,
wherein N is the number of carbon atoms that a main chain of the aliphatic hydrocarbon group as R has.

### [Item 5]

The surface modifier according to any one of items 1 to 5, wherein R has 1 or more and 3 or less of the alkylsilyl groups.

### [Item 6]

The surface modifier according to any one of items 1 to 5, wherein X is a 1+n valent group composed of one or more selected from the group consisting of:
X¹ composed of one or more selected from the group consisting of a direct bond, —O—, —C(═O)—, —S(═O)₂—, —NR′—, —C(OR′)R′—, and —C(OR′)(—)₂, wherein R′ is independently at each occurrence a hydrogen atom or a hydrocarbon group having 1 to 4 carbon atom; and
X² being a hydrocarbon group having 1 to 40 carbon atoms and optionally having a substituent.

### [Item 7]

The surface modifier according to any one of items 1 to 6, wherein X is a group represented by

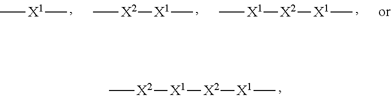

wherein X¹ is independently at each occurrence a group represented by
a direct bond,

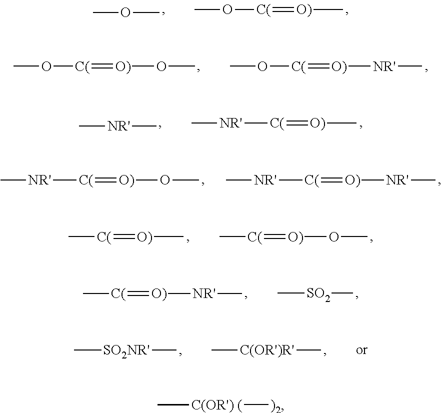

wherein R′ is independently at each occurrence a hydrogen atom or a hydrocarbon group having 1 to 4 carbon atoms, and
X² is a hydrocarbon group having 1 to 40 carbon atoms and optionally having a substituent.

### [Item 8]

The surface modifier according to any one of items 1 to 7, wherein X is

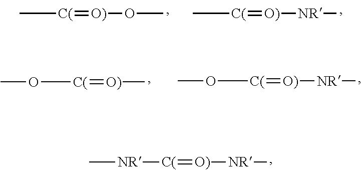

wherein R′ is independently at each occurrence a hydrogen atom or a hydrocarbon group having 1 to 4 carbon atoms.

### [Item 9]

The surface modifier according to any one of items 1 to 8, wherein the liquid-repellent compound is a compound formed by modifying at least one selected from the group consisting of a polycarboxylic acid, a polyol, a polyamine, an aromatic compound, a nitrogen-containing cyclic compound, an isocyanate derivative, and derivatives thereof, with the Z group.

### [Item 10]

The surface modifier according to any one of items 1 to 9, wherein
the liquid-repellent compound is a compound formed by replacing hydroxy groups of one or more carboxyl groups of a polycarboxylic acid each with the Z group, and
the polycarboxylic acid is at least one selected from the group consisting of a dicarboxylic acid, a tricarboxylic acid, a tetracarboxylic acid, and a polymer of a carboxyl group-containing compound.

### [Item 11]

The surface modifier according to item 10, wherein
the polycarboxylic acid is at least one selected from the group consisting of:
citric acid, malic acid, glutaric acid, adipic acid, phthalic acid, alginic acid, tartaric acid, oxalic acid, malonic acid, succinic acid, fumaric acid, maleic acid, aldaric acid;
tricarballylic acid, t-aconitic acid, trimellitic acid;
pyromellitic acid, and derivatives thereof.

### [Item 12]

The surface modifier according to any one of items 1 to 11, wherein the liquid-repellent compound is a polymer containing repeating units derived from a compound containing the Z group and represented by the following formula:

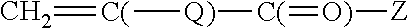

wherein Q is a hydrogen atom, a monovalent organic group, or a halogen atom except a fluorine atom.

### [Item 13]

The surface modifier according to claim 12, wherein
Q is a hydrogen atom or a methyl group,
X is —O—,
R is independently at each occurrence an aliphatic hydrocarbon group having 4 or more and 20 or less carbon atoms and having 1 or more and 2 or less alkylsilyl groups, and
R¹ in the alkylsilyl group(s) is each independently a hydrogen atom or a methyl group, and at least one R¹ is a methyl group.

### [Item 14]

The surface modifier according to any one of items 9 to 13, wherein
the liquid-repellent compound is a compound formed by replacing one or more hydroxy groups of a polyol each with the Z group, and
the polyol is a compound formed by modifying at least one compound selected from a monosaccharide, an oligosaccharide, a polysaccharide, a sugar alcohol, a hydroxy acid, an amino acid, a vitamin, a flavonol, a hydroxyhydrocarbon, and a polymer of a hydroxy group-containing compound, with the Z group.

### [Item 15]

The surface modifier according to item 14, wherein the polyol is at least one selected from the group consisting of:
glucose, fructose, galactose, xylose;
sucrose, cycloamylose, cyclodextrin, maltose, trehalose, lactose, sucralose;
sorbitol, maltitol, erythritol, isomalt, lactitol, mannitol, xylitol, sorbitan, lactitol;
starch, cellulose, curdlan, pullulan, alginic acid, carrageenan, guar gum, chitin, chitosan, locust bean gum, kappa-carrageenan, iota-carrageenan, isomaltodextrin, gellan gum, tamarind seed gum;
kojic acid, quinic acid, chlorogenic acid, gluconic acid, aldonic acid, uronic acid;
glucosamine;
ascorbic acid, inositol;
catechin, quercetin, anthocyanin;
glycerol, ethylene glycol, propylene glycol, diethylene glycol, triethylene glycol, tetraethylene glycol, neopentyl glycol, trimethylene glycol, trimethylolpropane, trimethylolethane;
polyglycerol, polyvinyl alcohol, hydroxyethyl (meth)acrylate polymer, hydroxypropyl (meth)acrylate polymer, and hydroxybutyl (meth)acrylate polymer, and derivatives thereof.

### [Item 16]

The surface modifier according to 9 to 15, wherein
the liquid-repellent compound is a compound formed by replacing hydrogen atoms bonded to one or more nitrogen atoms of a polyamine each with the Z group, and
the polyamine is composed of a mono to trivalent amino group and a chain saturated aliphatic hydrocarbon group or aromatic hydrocarbon group optionally interrupted by an oxygen atom and/or a sulfur atom, with a mole ratio between carbon atom and nitrogen atom (C/N ratio) being 8 or less.

### [Item 17]

The surface modifier according to any one of 9 to 16, wherein
the liquid-repellent compound is a compound represented by the following formula:

A(-Z)ₘ
wherein A is an m valent group obtained by removing m hydrogen atoms from an aromatic ring having 7 or more carbon atoms or a nitrogen-containing cyclic compound having 5 or more carbon atoms, with the aromatic ring or nitrogen-containing cyclic compound optionally having a substituent.

### [Item 18]

The surface modifier according to any one of items 9 to 17, wherein the liquid-repellent compound is a compound formed by modifying an isocyanate derivative with the Z group, and the isocyanate derivative is a polyurethane obtained by reacting an isocyanate group-containing compound and an isocyanate-reactive compound.

### [Item 19]

The surface modifier according to item 18, wherein the isocyanate group-containing compound is a triisocyanate.

### [Item 20]

The surface modifier according to any one of items 2 to 19, comprising one or more selected from the group consisting of a surfactant, a silicone, a wax, an organic acid, and a curing agent.

### [Item 21]

The surface modifier according to any one of items 2 to 20, which is for a textile product or a paper product.

### [Item 22]

A product treated with the surface modifier according to any one of items 1 to 21.

### [Item 23]

The product according to item 22, which is a textile product or a paper product.

### [Item 24]

A method for producing a treated product, comprising treating a substrate with the surface modifier according to any one of items 1 to 21.

### [Item 25]

The method according to item 24, wherein the treatment is internal addition treatment.

1. A surface modifier comprising a liquid-repellent compound having a Z group represented by the following formula: 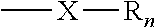
wherein X is a direct bond or a 1+n valent group,
R is independently at each occurrence an aliphatic hydrocarbon group having 4 or more and 40 or less carbon atoms, having at least one alkylsilyl group, and optionally having a substituent, and
n is 1 or more and 3 or less,
wherein the alkylsilyl group is represented by the following formula: 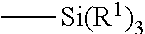
wherein R¹ is each independently a hydrogen atom or an aliphatic hydrocarbon group having 1 to 10 carbon atoms and optionally having a substituent, and at least one R¹ is an aliphatic hydrocarbon group having 1 or more and 10 or less carbon atoms and optionally having a substituent.

2. The surface modifier according to claim 1, wherein the liquid-repellent compound has a solvation free energy of −1.50 kcal/mol or more.

3. The surface modifier according to claim 2, wherein the aliphatic hydrocarbon group as R has 4 or more and 30 or less carbon atoms.

4. The surface modifier according to claim 2, wherein when the carbon atom directly bonded to X among the carbon atoms of the aliphatic hydrocarbon group as R is defined to be at position 1, the alkylsilyl group is bonded to at least one carbon atom at position 1 to position N/2,
wherein N is the number of carbon atoms that a main chain of the aliphatic hydrocarbon group as R has.

5. The surface modifier according to claim 2, wherein R has 1 or more and 3 or less of the alkylsilyl groups.

6. The surface modifier according to claim 2, wherein X is a 1+n valent group composed of one or more selected from the group consisting of:
X¹ composed of one or more selected from the group consisting of a direct bond, —O—, —C(═O)—, —S(═O)₂—, —NR′—, —C(OR′)R′—, and —C(OR′)(—)₂, wherein R′ is independently at each occurrence a hydrogen atom or a hydrocarbon group having 1 to 4 carbon atom; and
X² being a hydrocarbon group having 1 to 40 carbon atoms and optionally having a substituent.

7. The surface modifier according to claim 2, wherein X is a group represented by 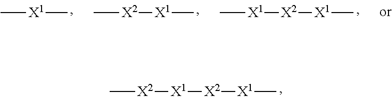
wherein X¹ is independently at each occurrence a group represented by
a direct bond, 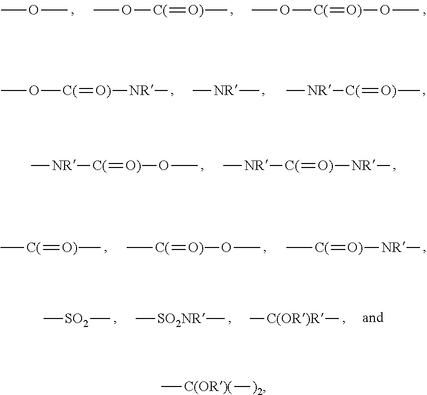
wherein R′ is independently at each occurrence a hydrogen atom or a hydrocarbon group having 1 to 4 carbon atoms, and
X² is a hydrocarbon group having 1 to 40 carbon atoms and optionally having a substituent.

8. The surface modifier according to claim 2, wherein X is 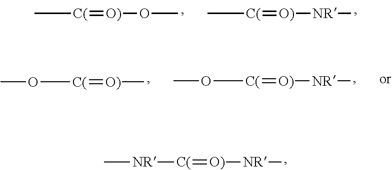
wherein R′ is independently at each occurrence a hydrogen atom or a hydrocarbon group having 1 to 4 carbon atoms.

9. The surface modifier according to claim 3, wherein the liquid-repellent compound is a compound formed by modifying at least one selected from the group consisting of a polycarboxylic acid, a polyol, a polyamine, an aromatic compound, a nitrogen-containing cyclic compound, an isocyanate derivative, and derivatives thereof, with the Z group.

10. The surface modifier according to claim 9, wherein
the liquid-repellent compound is a compound formed by replacing hydroxy groups of one or more carboxyl groups of a polycarboxylic acid each with the Z group, and
the polycarboxylic acid is at least one selected from the group consisting of a dicarboxylic acid, a tricarboxylic acid, a tetracarboxylic acid, and a polymer of a carboxyl group-containing compound.

11. The surface modifier according to claim 10, wherein
the polycarboxylic acid is at least one selected from the group consisting of:
citric acid, malic acid, glutaric acid, adipic acid, phthalic acid, alginic acid, tartaric acid, oxalic acid, malonic acid, succinic acid, fumaric acid, maleic acid, aldaric acid;
tricarballylic acid, t-aconitic acid, trimellitic acid;
pyromellitic acid, and derivatives thereof.

12. The surface modifier according to claim 2, wherein the liquid-repellent compound is a polymer containing repeating units derived from a compound containing the Z group and represented by the following formula: 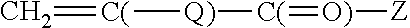
wherein Q is a hydrogen atom, a monovalent organic group, or a halogen atom except a fluorine atom.

13. The surface modifier according to claim 12, wherein
Q is a hydrogen atom or a methyl group,
X is —O—,
R is independently at each occurrence an aliphatic hydrocarbon group having 4 or more and 20 or less carbon atoms and having 1 or more and 2 or less alkylsilyl groups, and
R¹ in the alkylsilyl group(s) is each independently a hydrogen atom or a methyl group, and at least one R¹ is a methyl group.

14. The surface modifier according to claim 9, wherein
the liquid-repellent compound is a compound formed by replacing one or more hydroxy groups of a polyol each with the Z group, and
the polyol is a compound formed by modifying at least one compound selected from a monosaccharide, an oligosaccharide, a polysaccharide, a sugar alcohol, a hydroxy acid, an amino acid, a vitamin, a flavonol, a hydroxyhydrocarbon, and a polymer of a hydroxy group-containing compound, with the Z group.

15. The surface modifier according to claim 14, wherein the polyol is at least one selected from the group consisting of:
glucose, fructose, galactose, xylose;
sucrose, cycloamylose, cyclodextrin, maltose, trehalose, lactose, sucralose;
sorbitol, maltitol, erythritol, isomalt, lactitol, mannitol, xylitol, sorbitan, lactitol;
starch, cellulose, curdlan, pullulan, alginic acid, carrageenan, guar gum, chitin, chitosan, locust bean gum, kappa-carrageenan, iota-carrageenan, isomaltodextrin, gellan gum, tamarind seed gum;
kojic acid, quinic acid, chlorogenic acid, gluconic acid, aldonic acid, uronic acid;
glucosamine;
ascorbic acid, inositol;
catechin, quercetin, anthocyanin;
glycerol, ethylene glycol, propylene glycol,
diethylene glycol, triethylene glycol, tetraethylene glycol, neopentyl glycol, trimethylene glycol, trimethylolpropane, trimethylolethane;
polyglycerol, polyvinyl alcohol, hydroxyethyl (meth)acrylate polymer, hydroxypropyl (meth)acrylate polymer, and hydroxybutyl (meth)acrylate polymer, and derivatives thereof.

16. The surface modifier according to claim 9, wherein
the liquid-repellent compound is a compound formed by replacing hydrogen atoms bonded to one or more nitrogen atoms of a polyamine each with the Z group, and
the polyamine is composed of a mono to trivalent amino group and a chain saturated aliphatic hydrocarbon group or aromatic hydrocarbon group optionally interrupted by an oxygen atom and/or a sulfur atom, with a mole ratio between carbon atom and nitrogen atom (C/N ratio) being 8 or less.

17. The surface modifier according to claim 9, wherein
the liquid-repellent compound is a compound represented by the following formula: 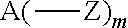
wherein A is an m valent group obtained by removing m hydrogen atoms from an aromatic ring having 7 or more carbon atoms or a nitrogen-containing cyclic compound having 5 or more carbon atoms, with the aromatic ring or nitrogen-containing cyclic compound optionally having a substituent.

18. The surface modifier according to claim 9, wherein the liquid-repellent compound is a compound formed by modifying an isocyanate derivative with the Z group, and the isocyanate derivative is a polyurethane obtained by reacting an isocyanate group-containing compound and an isocyanate-reactive compound.

19. The surface modifier according to claim 18, wherein the isocyanate group-containing compound is a triisocyanate.

20. The surface modifier according to claim 2, comprising one or more selected from the group consisting of a surfactant, a silicone, a wax, an organic acid, and a curing agent.

21. The surface modifier according to claim 2, which is for a textile product or a paper product.

22. A product treated with the surface modifier according to claim 1.

23. The product according to claim 22, which is a textile product or a paper product.

24. A method for producing a treated product, comprising treating a substrate with the surface modifier according to claim 1.

25. The method according to claim 24, wherein the treatment is internal addition treatment.
